(19) United States
(12) Patent Application Publication
(10) Pub. No.: US 2026/0267815 A1
(43) Pub. Date: Sep. 10, 2026

(54) SYSTEM FOR IMPLEMENTING DIAGNOSIS AND MONITORING OF OPTICAL LINK

(71) Applicant: OPTICIS CO., LTD., Seongnam-si (KR)

(72) Inventors: Dong Pyeong YANG, Seongnam-si (KR); Doo Soo HA, Seoul (KR)

(21) Appl. No.: 19/540,293

(22) Filed: Feb. 13, 2026

(30) Foreign Application Priority Data
Mar. 5, 2025 (KR) 10-2025-0028380

(51) Int. Cl. G06F 13/38

(52) U.S. Cl. CPC G06F 13/385

(57) ABSTRACT

A diagnosis and monitoring system for implementing a diagnosis and monitoring function of a plurality of optical links is provided. The system is capable of monitoring diagnosis data about statuses of optical links, such as information about connection statuses of optical links, information about operating statuses of optical links such as operating temperature or operating status, and identification information of optical links themselves, and providing diagnosis and monitoring on video data including channel configuration information of a main channel through which video data is transmitted and rendering configuration information about the video data.

### CROSS-REFERENCE TO RELATED APPLICATION

This application is based on and claims priority under 35 U.S.C. § 119 to Korean Patent Application No. 10-2025-0028380, filed on Mar. 5, 2025, in the Korean Intellectual Property Office, the disclosure of which is incorporated by reference herein in its entirety.

### BACKGROUND

### 1. Field

The disclosure relates to a system for implementing diagnosis and monitoring of an optical link.

### 2. Description of the Related Art

Optical links provide an interface for optical communication between a source device that generates a video signal and a sink device that forms a video from the video signal generated by the source device. The optical links may include a video signal line for transmitting video data and an auxiliary signal line for transmitting auxiliary data for the configuration information about the source device or the sink device in addition to the video data.

### SUMMARY

Provided is a system capable of implementing diagnosis and monitoring of a plurality of optical links, the system being capable of monitoring diagnosis data about statuses of optical links, such as information about connection statuses of optical links, information about operating statuses of optical links such as operating temperature or operating status, and identification information about optical links themselves, and providing diagnosis and monitoring on video data including channel configuration information about a main channel through which video data is transmitted and rendering configuration information about the video data.

Additional aspects will be set forth in part in the description which follows and, in part, will be apparent from the description, or may be learned by practice of the presented embodiments of the disclosure.

According to an aspect of the disclosure, a system for implementing diagnosis and monitoring of diagnosis data including status information of a plurality of optical links forming a main channel for transmitting video data and a side channel for transmitting video auxiliary data including rendering information about the video data or channel configuration information about the main channel includes a plurality of universal serial bus (USB) host controllers configured to form a communication host at the other end of a USB communication channel with each of the plurality of optical links as a communication host at one end, a field programmable gate array (FPGA) circuit to which the plurality of USB host controllers are connected in parallel, and a microcontroller (MCU) connected to the FPGA circuit.

For example, each of the plurality of optical links and each of the plurality of USB host controllers may form a one-to-one USB communication channel.

For example, the FPGA circuit may independently perform parallel processing input/output data with the plurality of USB host controllers connected in parallel.

For example, a data transmission channel through which input/output data with respect to the plurality of optical links are transmitted may be formed as a separate connection channel with respect to each of the plurality of optical links between the plurality of host controllers and the FPGA circuit, and formed as a single connection channel between the FPGA circuit and the MCU.

For example, the FPGA circuit may include a multiplexer for time division multiplexing (TDM) of a plurality of connection channels respectively connected to the plurality of optical links.

For example, the multiplexer may multiplex data related to the plurality of optical links, that is the multiplexer may multiplex data input and output through the plurality of connection channels through time-divided time slots, and
the MCU may perform multiprocessing on the data related to the plurality of optical links, that is the MCU may multiprocess the data input and output through the multiplexer of the above FPGA circuit in a time division manner.

For example, the multiplexer may implement asynchronous TDM (ATDM) in which time slots allocated to an optical link switched from a USB connection status to a USB disconnection status are allocated to another optical link in the USB connection status.

For example, the MCU may skip to a task related to the other optical link in the USB connection status without performing a task related to the optical link switched to the USB disconnection status according to ATDM of the multiplexer.

For example, each of the plurality of USB host controllers may include a general purpose IO (GPIO) pin of which output level is switched to a high/low signal according to USB connection/disconnection of an optical link forming a one-to-one USB communication channel with itself.

For example, the MCU may initiate a reset operation on each of the plurality of USB host controllers in which switching of the output level of the GPIO pin is detected.

For example, as the reset operation of each of the plurality of USB host controllers is initiated, a configuration channel (CC) of the USB host controller may be connected to a pull-up resistor and the output level is initialized so that each of the plurality of USB host controllers is role-selected as a host (down facing port (DFP)) according to a USB connection.

For example, each of the plurality of USB host controllers may switch the output level of the GPIO pin to a high signal indicating the USB connection, when it is determined that a USB device corresponds to a range of a preset optical link as a target of diagnosis and monitoring from a combination of a vender ID (VID) and a product ID (PID) obtained through device emulation of the USB device where a connection is detected.

For example, the system may further include a communication module for configuring an Ethernet communication channel between the system and an administrator interface.

According to a power on/off control command of each of the plurality of optical links received from the administrator interface, the MCU may control each of the plurality of USB host controllers forming the communication host of the USB communication channel with each of the plurality of optical links to initiate or cut off power supply to each of the plurality of optical links through a USB connection from each of the plurality of USB host controllers, and
each of the plurality of USB host controllers may switch the output level of the GPIO pin to instruct a USB connection of each of the plurality of optical links to which power supply is initiated or a USB disconnection of each of the plurality of optical links to which power supply is cut off.

For example, the system may further include a universal achromous receiver/transmitter (UART)-parallel converter connected between the FPGA circuit and each of the plurality of USB host controllers along the data transmission channel through which input/output data with respect to the plurality of optical links are transmitted.

Each of the plurality of USB host controllers may include
a UART interface as a thread executed to convert UART communication data transmitted from the UART-parallel converter into USB communication data transmitted toward each of the plurality of optical links, and
a USB interface as a thread executed to convert the USB communication data transmitted from each of the plurality of optical links into the UART communication data transmitted toward the UART-parallel converter.

For example, the UART interface and the USB interface may execute a UART-USB conversion
after a series of entire continuous data from one side to the other side between the UART-parallel converter and each of the plurality of USB host controllers is completely transmitted to a last byte, or
after a series of continuous data from one side to the other side between each of the plurality of the optical links and each of the plurality of USB host controllers is completely transmitted to the last byte.

For example, the threads forming the UART interface and the USB interface may be executed independently of each other, whereas global variables of USB connection/disconnection may be stored in a data area of memory that is shared within a same process providing an execution environment and be shared between different threads.

For example, the diagnosis data may include at least one of connection statuses of the plurality of the optical links, operating statuses of the plurality of the optical links, or identification information of the plurality of the optical links themselves.

For example, the system may provide diagnosis and monitoring of the video auxiliary data, in addition to the status information of each of the plurality of the optical links.

For example, the video auxiliary data may include channel configuration data related to channel configuration of the main channel for transmitting the video data and rendering configuration data related to rendering of a display sink where the video data is rendered.

For example, according to a control command received from an administrator interface connected over a communication network, the MCU may perform processing for requesting the diagnosis data and/or the video auxiliary data, receiving the requested diagnosis data and/or changing the diagnosis data and/or the video auxiliary data.

For example, each of the plurality of optical links may form the USB communication channel with each of the plurality of USB host controllers through an FPGA block connected on the side channel.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for explaining a main channel for transmitting video data and a side channel for transmitting video auxiliary data and diagnosis data in a display port (DP) to which an optical link may be applied for diagnosis and monitoring of a system for implementing diagnosis and monitoring of the optical link (hereinafter referred to as a diagnosis and monitoring system) according to an embodiment;

FIG. 2 is a diagram for explaining a main channel for transmitting video data and a side channel for transmitting video auxiliary data and diagnosis data in a high-definition multimedia interface (HDMI) to which an optical link may be applied for diagnosis and monitoring target of a diagnosis and monitoring system according to an embodiment;

FIG. 3 is a diagram for explaining an overall structure of a diagnosis and monitoring system for providing diagnosis and monitoring of an optical link according to an embodiment;

FIG. 4 is a diagram for explaining a universal serial bus (USB) host controller shown in FIG. 3;

FIG. 5 is a diagram for explaining multiplexing a plurality of data transmission channels respectively connected to optical links through a single connection channel between a field programmable gate array (FPGA) circuit and a microcontroller (MCU) shown in FIG. 3 from time division multiplexing (TDM) between the FPGA and the MCU;

FIG. 6A is a diagram for explaining asynchronous TDM (ATDM) as an embodiment of the TDM shown in FIG. 5;

FIG. 6B is a diagram for explaining synchronous TDM (STDM) in contrast to the ATDM shown in FIG. 6A;

FIG. 7 is a diagram for explaining a data structure of universal achromous receiver/transmitter (UART) communication data that is converted from a USB interface of a USB host controller with USB communication data as input and is transmitted toward a UART-parallel converter, which is a diagram for explaining the UART communication data structure including Stop bit, Data bit, Parity bit, Stop bit, and IDLE period;

FIG. 8 is a diagram for explaining a USB connection between the USB host controller and the optical link shown in FIG. 3 and shows, in the USB connection between the USB host controller as a host (down facing port (DFP)) and the optical link as a device (up facing port (UFP)), MUX for allowing an un-flipped or flipped connection according to a plug orientation according to a connection status of each other and CC Logic and Vconn switch for switching control between input/output channels of the MUX, and power supply of an electronically marked IC (EMIC);

FIG. 9 is a diagram for explaining a pin configuration of a USB port (USB C-type) and configuration control (CC) in a USB connection between the USB host controller and the optical link shown in FIG. 3 and explains configuration channels CC1 and CC2 detecting USB connection/disconnection, and involving role determination between USB connection hosts and a plug orientation (un-flipped or flipped) and power delivery (PD) communication (or baseband communication);

FIG. 10 is a diagram for explaining USB communication between the USB host controller and the optical link shown in FIG. 3, in which, in the USB communication between the USB host controller as a host (a DFP) and the optical link as a device (a UFP), the diagram explaining a pull-up resistor Rp detecting a USB connection and a plug orientation (un-flipped or flipped), and for role determination, connected to a CC of the USB host controller forming the host, a pull-down resistor Rd connected to a CC of the optical link forming the device, and a resistor Ra capable of detecting an active cable circuitry such as an EMIC;

FIG. 11 is a diagram for explaining USB communication between the USB host controller and the optical link shown in FIG. 3 and explains PD communication (or baseband communication) related to power supply and role determination between a CC of the USB host controller and a CC of the optical link and is a diagram for explaining PD communication encoded in Bipase Mark Coding (BMC);

FIG. 12 is a diagram for explaining a Universal Asynchronous Receiver Transmitter (UART) interface and an USB interface of the USB host controller shown in FIG. 4 and explains, in a process of providing an execution environment of two different threads (thread A and thread B) of the UART interface to convert UART communication data as input into USB communication data and the USB interface to convert USB communication data as input into UART communication data, a memory structure for explaining the UART interface and the USB interface as two different threads (thread A and thread B) provided with an execution environment in the same process in which a code area of the memory (e.g., storing a function), a data area (e.g., storing a global variable), and a heap area (dynamic allocation memory) are shared and a stack area (e.g., storing a parameter of the function) is allocated separately;

FIG. 13 is a diagram for explaining storing main functions of thread A and thread B (thread A's main and thread B's main), and functions (add, minus, divide, and multiple) called from the main functions in a shared code area in the UART interface and the USB interface as two different threads (thread A and thread B) provided with the execution environment in the same process shown in FIG. 12;

FIGS. 14A and 14B are diagrams for explaining an optical transmission module (transmitter) for transmitting video data and an optical reception module (receiver) for receiving video data as optical communication modules of an optical link that forms a USB connection with the diagnosis and monitoring system shown in FIG. 3, the diagrams explaining a configuration including a video signal adjuster (Re-timer) connected to a main channel for transmitting the video data, a field programmable gate array (FPGA) block connected on a side channel for transmission of video auxiliary data and diagnosis data, a photoelectronic conversion element connected to the main channel and the side channel, and a USB-UART converter formed on a data transmission channel between the diagnosis and monitoring system and the FPGA block connected through USB communication, in each of the optical transmission module (transmitter) and the optical reception module (receiver);

FIG. 15 is a diagram for explaining the USB-UART converter of the optical transmission module and the optical reception module (optical communication module) shown in FIGS. 14A and 14B, the diagram explaining a USB interface for converting USB communication data as input transmitted from the diagnosis and monitoring system connected via USB to the optical communication module and the optical receiving module (optical communication module) into UART communication data and a UART interface for converting UART communication data as input transmitted from a FPGA block of the optical transmission module and the optical reception module into USB communication data;

FIG. 16 is a diagram for explaining the FPGA block configured in the optical communication module of FIG. 15, the diagram explaining a configuration including FPGA control logic in which logic or process is configured for processing video auxiliary data and diagnosis data, memory RAM storing the video auxiliary data and the diagnosis data processed from the FPGA control logic, and a Serializer+Deserializer (SerDes) for conversion between serial data and parallel data which are input to and output from the FPGA block, and a configuration of the FPGA block including a UART communication channel formed between the FPGA block and a UART-USB converter within the optical communication module including the FPGA block, and a communication channel formed between a peripheral circuit to generate diagnosis data including operating statuses of an optical link, such as operating temperature and operating voltage;

FIG. 17 is a diagram for explaining TDM of video auxiliary data and diagnosis data to transmit the video auxiliary data and the diagnosis data together through a side channel, the diagram explaining forming a data frame in which the video auxiliary data and the diagnosis data are TDM through a multiplexer from an input channel storing the video auxiliary data and the diagnosis data or an input register connected to the input channel and are multiplexed through TDM time slots or sub-frames, and forming a data frame of serial data from SerDes with a data frame of parallel data as input;

FIG. 18 is a diagram for schematically explaining a processing flow of video auxiliary data and diagnosis data transmitted through a side channel, the diagram explaining an FPGA block including an encoder/decoder having the flow, as input, of multiplexed video auxiliary data and diagnosis data output from MUX for multiplexing first to eight input channels input from an input register of FPGA control logic and a configuration of SerDes to convert parallel data and serial data of the video auxiliary data and the diagnosis data into each other;

FIG. 19 is a diagram for explaining a data frame of non-diagnosis instance including only video auxiliary data without including diagnosis data;

FIG. 20 is a diagram for explaining a data frame of diagnosis instance including diagnosis data along with video data; and

FIG. 21 is a diagram for explaining implementing synchronous TDM (STDM) that stuffs time slots or sub-frames allocated to diagnosis data with stuffing symbols in a data frame of non-diagnosis instance where diagnosis data does not exist according to an embodiment, the diagram explaining compatibility with an optical link to which a certain transmission capacity is allocated in the data frame that do not include diagnosis data.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a system for implementing diagnosis and monitoring of an optical link (hereinafter referred to as a diagnosis and monitoring system) according to an embodiment will be described with reference to the drawings attached to the specification.

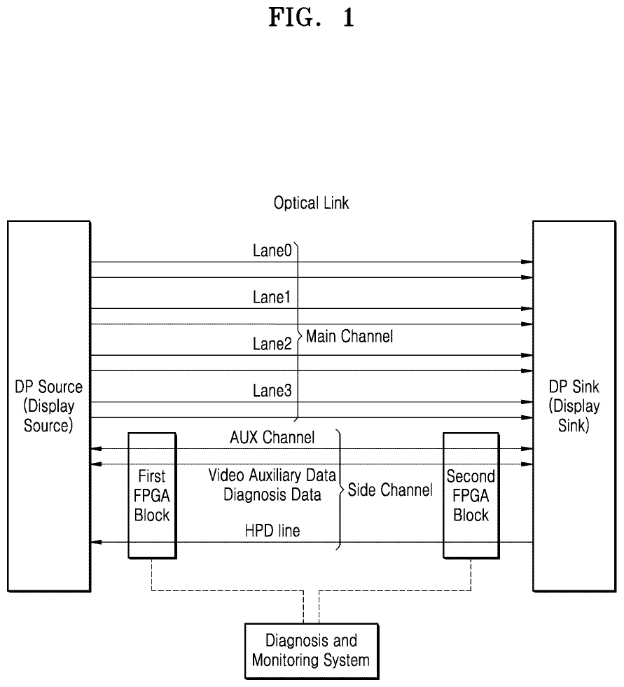

FIG. 1 is a diagram for explaining a main channel for transmitting video data and a side channel for transmitting video auxiliary data and diagnosis data in a display port (DP) to which an optical link may be applied for a diagnosis and monitoring target of a diagnosis and monitoring system according to an embodiment.

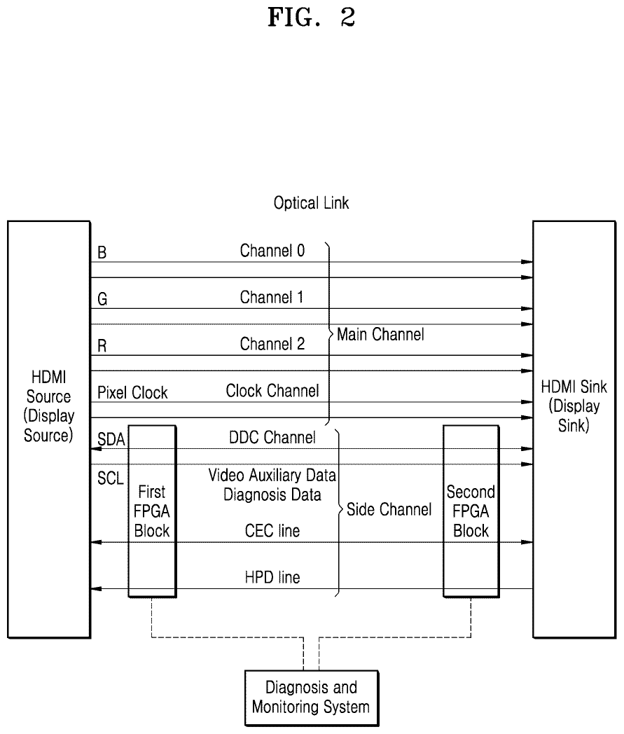

FIG. 2 is a diagram for explaining a main channel for transmitting video data and a side channel for transmitting video auxiliary data and diagnosis data in a high-definition multimedia interface (HDMI) to which an optical link may be applied for a diagnosis and monitoring target of a diagnosis and monitoring system according to an embodiment.

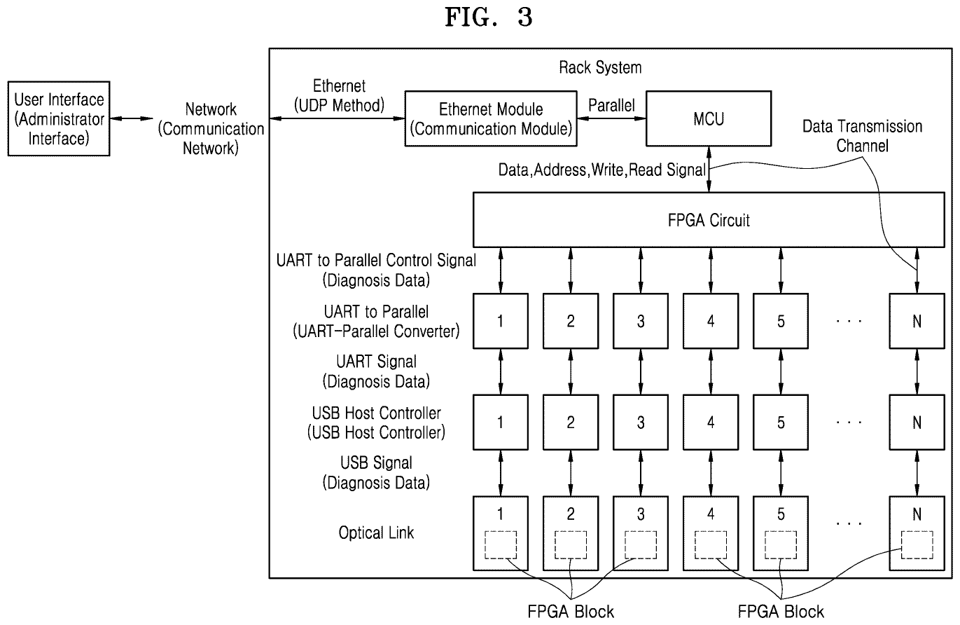

FIG. 3 is a diagram for explaining an overall structure of a diagnosis and monitoring system for providing diagnosis and monitoring of an optical link according to an embodiment.

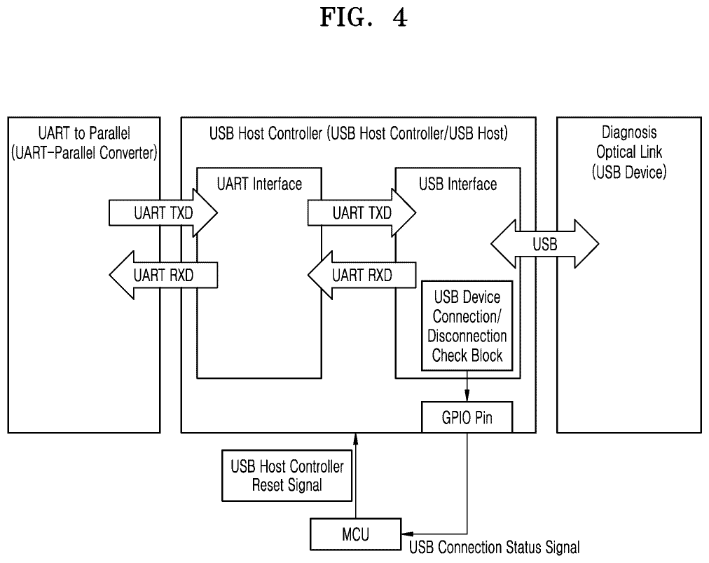

FIG. 4 is a diagram for explaining a universal serial bus (USB) host controller shown in FIG. 3.

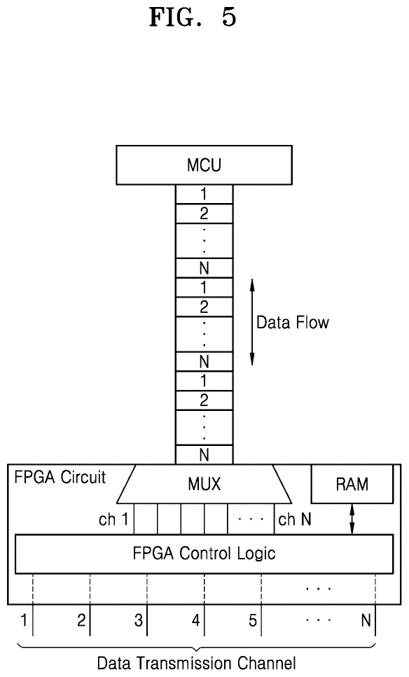

FIG. 5 is a diagram for explaining multiplexing a plurality of data transmission channels respectively connected to optical links through a single connection channel between a field programmable gate array (FPGA) circuit and a microcontroller (MCU) shown in FIG. 3 from time division multiplexing (TDM) between the FPGA and the MCU.

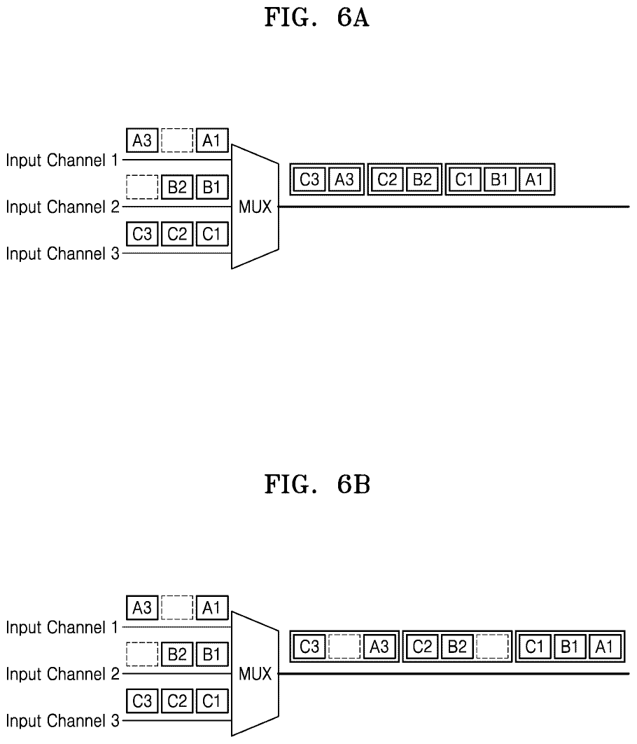

FIG. 6A is a diagram for explaining asynchronous TDM (ATDM) as an embodiment of the TDM shown in FIG. 5.

FIG. 6B is a diagram for explaining synchronous TDM (STDM) in contrast to the ATDM shown in FIG. 6A.

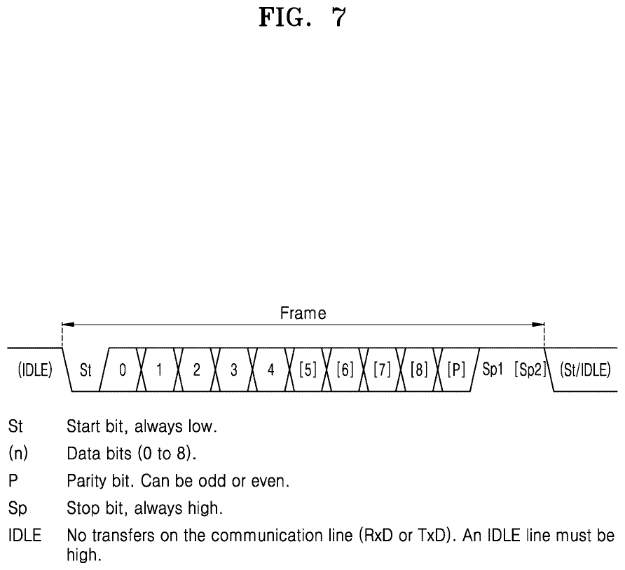

FIG. 7 is a diagram for explaining a data structure of universal achromous receiver/transmitter (UART) communication data that is converted from a USB interface of a USB host controller with USB communication data as input and is transmitted toward a UART-parallel converter, the diagram explaining the UART communication data structure including Stop bit, Data bit, Parity bit, Stop bit, and IDLE period.

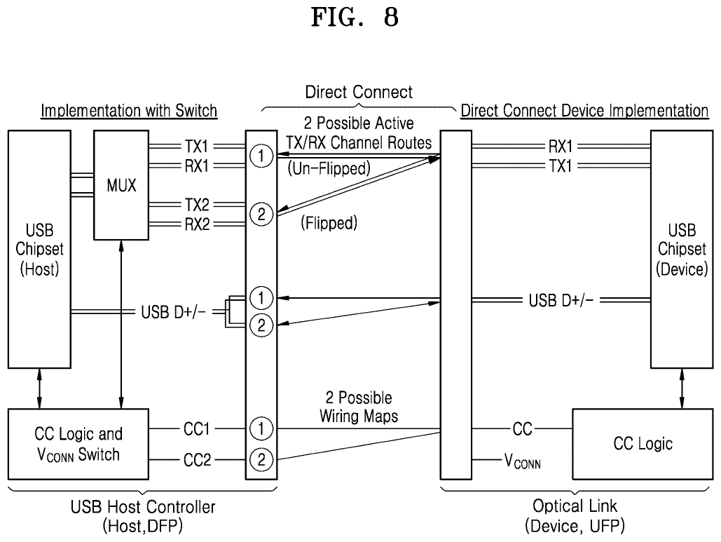

FIG. 8 is a diagram for explaining a USB connection between the USB host controller and the optical link shown in FIG. 3 and shows, in the USB connection between the USB host controller as a host (down facing port (DFP)) and the optical link as a device (up facing port (UFP)), MUX for allowing an un-flipped or flipped connection according to a plug orientation according to a connection status of each other and CC Logic and Vconn switch for switching control between input/output channels of the MUX, and power supply of an electronically marked IC (EMIC).

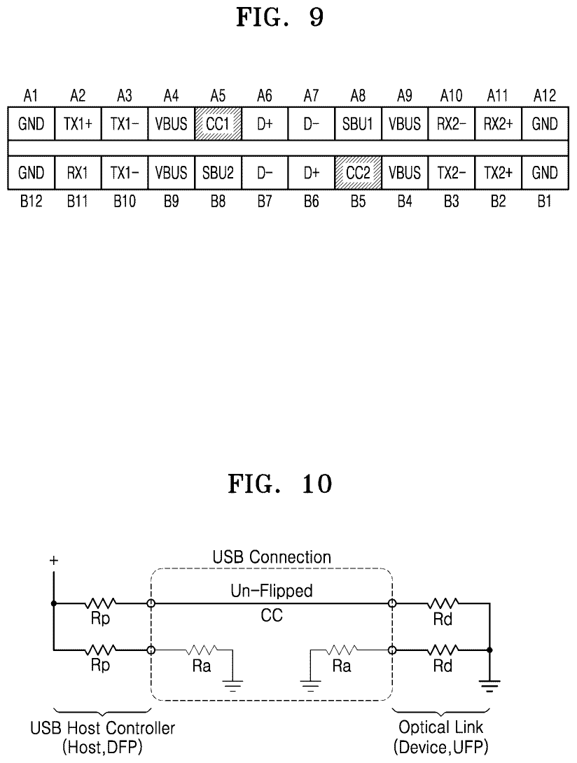

FIG. 9 is a diagram for explaining a pin configuration of a USB port (USB C-type) and configuration control (CC) in a USB connection between the USB host controller and the optical link shown in FIG. 3, the diagram explaining configuration channels CC1 and CC2 detecting USB connection/disconnection, and involving role determination between USB connection hosts and a plug orientation (un-flipped or flipped) and power delivery (PD) communication (or baseband communication).

FIG. 10 is a diagram for explaining USB communication between the USB host controller and the optical link shown in FIG. 3, in which, in the USB communication between the USB host controller as a host (a DFP) and the optical link as a device (a UFP), the diagram explaining a pull-up resistor Rp detecting a USB connection and a plug orientation (un-flipped or flipped), and for role determination, connected to a CC of the USB host controller forming the host, a pull-down resistor Rd connected to a CC of the optical link forming the device, and a resistor Ra capable of detecting an active cable circuitry such as an EMIC.

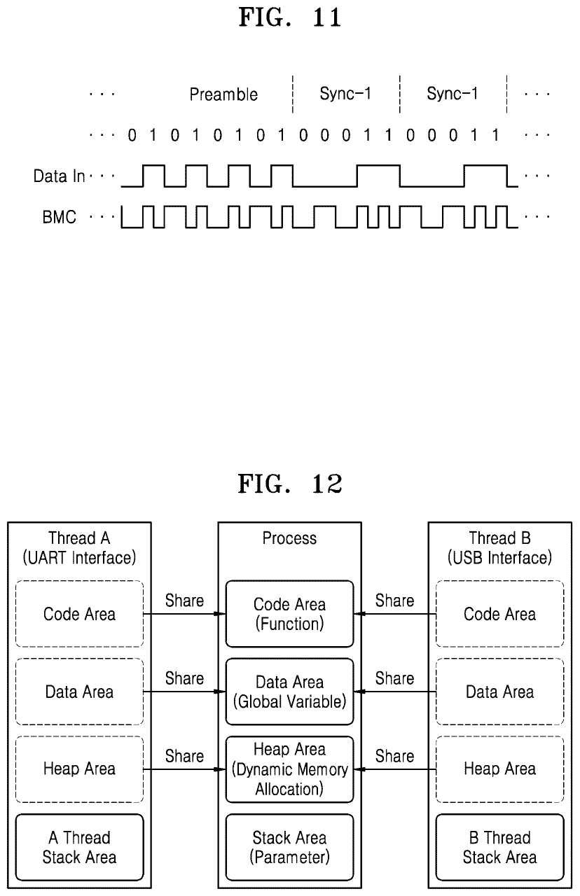

FIG. 11 is a diagram for explaining USB communication between the USB host controller and the optical link shown in FIG. 3, the diagram explaining PD communication (or baseband communication) related to power supply and role determination between a CC of the USB host controller and a CC of the optical link and is a diagram for explaining PD communication encoded in Bipase Mark Coding (BMC).

FIG. 12 is a diagram for explaining a Universal Asynchronous Receiver Transmitter (UART) interface and an USB interface of the USB host controller shown in FIG. 4, the diagram explaining, in a process of providing an execution environment of two different threads (thread A and thread B) of the UART interface to convert UART communication data as input into USB communication data and the USB interface to convert USB communication data as input into UART communication data, a memory structure for explaining the UART interface and the USB interface as two different threads (thread A and thread B) provided with an execution environment in the same process in which a code area of the memory (e.g., storing a function), a data area (e.g., storing a global variable), and a heap area (dynamic allocation memory) are shared and a stack area (e.g., stores parameters of the function) is (e.g., allocated separately.

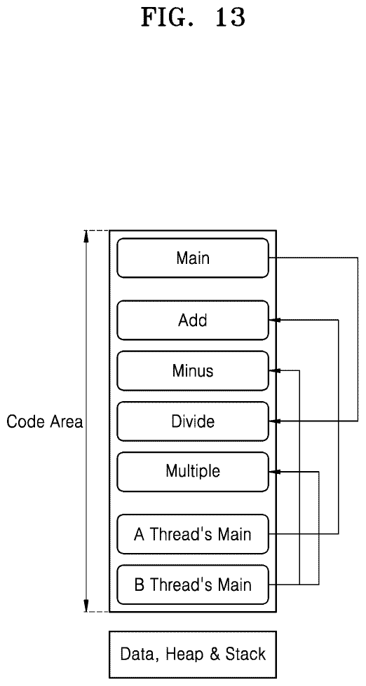

FIG. 13 is a diagram for explaining storing main functions of thread A and thread B (thread A's main and thread B's main), and functions (add, minus, divide, and multiple) called from the main functions in a shared code area in the UART interface and the USB interface as two different threads (thread A and thread B) provided with the execution environment in the same process shown in FIG. 12.

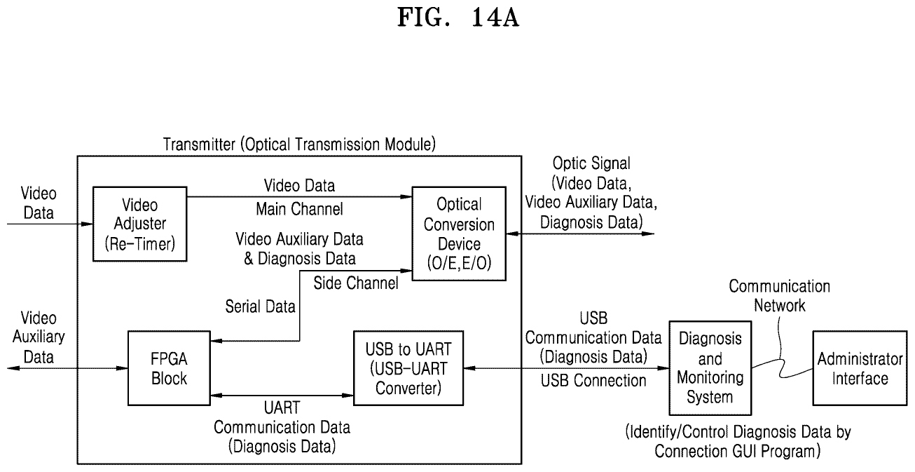

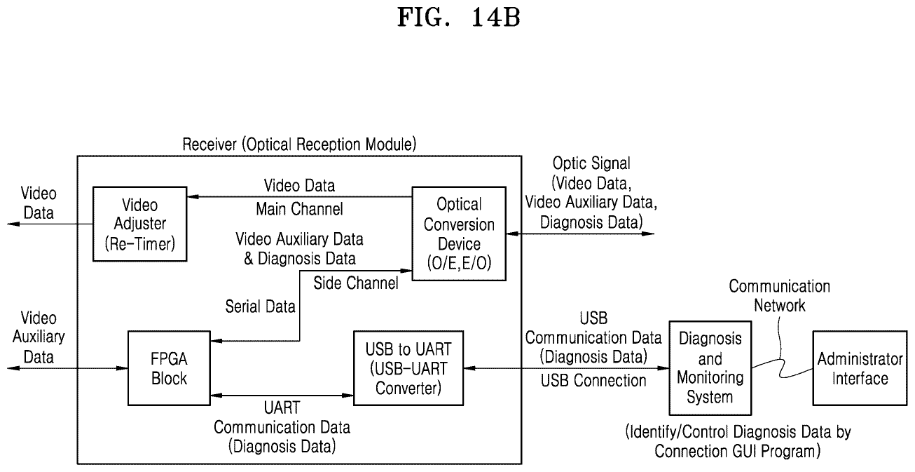

FIGS. 14A and 14B are diagrams for explaining an optical transmission module (transmitter) for transmitting video data and an optical reception module (receiver) for receiving video data as optical communication modules of an optical link that forms a USB connection with the diagnosis and monitoring system shown in FIG. 3, the diagrams explaining a configuration including a video signal adjuster (Re-timer) connected to a main channel for transmitting the video data, a field programmable gate array (FPGA) block connected on a side channel for transmission of video auxiliary data and diagnosis data, a photoelectronic conversion element connected to the main channel and the side channel, and a USB-UART converter formed on a data transmission channel between the diagnosis and monitoring system and the FPGA block connected through USB communication, in each of the optical transmission module (transmitter) and the optical reception module (receiver).

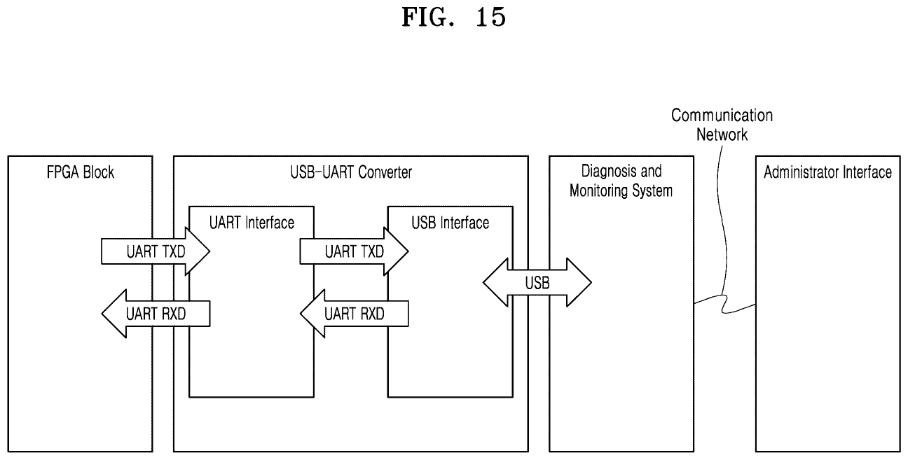

FIG. 15 is a diagram for explaining the USB-UART converter of the optical transmission module and the optical reception module (optical communication module) shown in FIGS. 14A and 14B, the diagram explaining a USB interface for converting USB communication data as input transmitted from the diagnosis and monitoring system connected via USB to the optical communication module and the optical receiving module (optical communication module) into UART communication data and a UART interface for converting UART communication data as input transmitted from a FPGA block of the optical transmission module and the optical reception module into USB communication data.

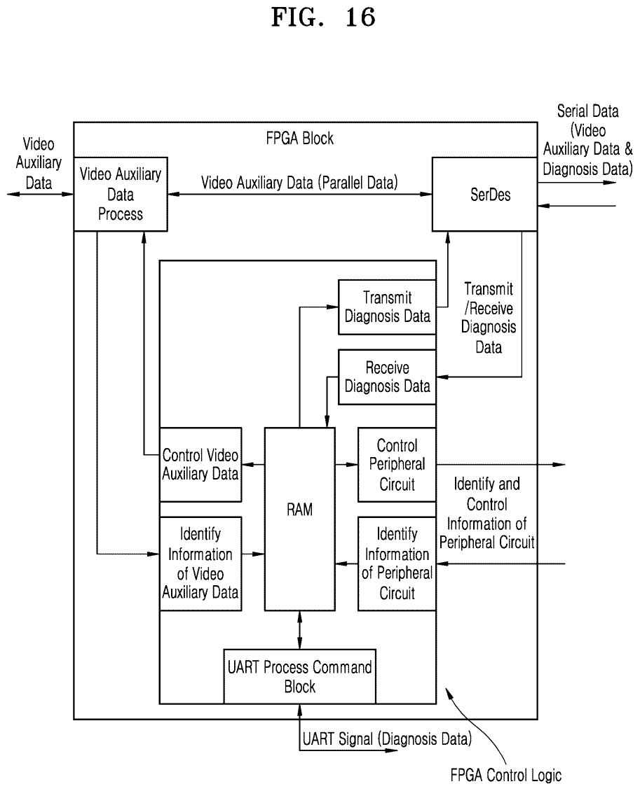

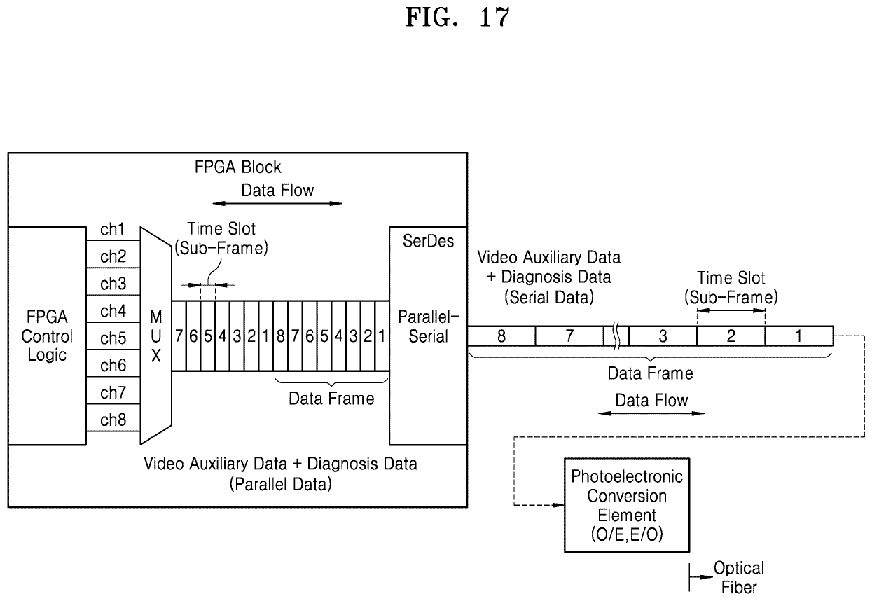

FIG. 16 is a diagram for explaining the FPGA block configured in the optical communication module of FIG. 15, the diagram explaining a configuration including FPGA control logic in which logic or process is configured for processing video auxiliary data and diagnosis data, memory RAM storing the video auxiliary data and the diagnosis data processed from the FPGA control logic, and SerDes for conversion between serial data and parallel data which are input to and output from the FPGA block, and a configuration of the FPGA block including a UART communication channel formed between the FPGA block and a UART-USB converter within the optical communication module including the FPGA block, and a communication channel formed between a peripheral circuit to generate diagnosis data including operating statuses of an optical link, such as operating temperature and operating voltage.

The system (hereinafter referred to as a diagnosis and monitoring system) for implementing diagnosis and monitoring of the optical link according to an embodiment may provide diagnosis and monitoring regarding a connection status of the optical link by transmitting, to an administrator interface, diagnosis data including overall status information of the optical link, including the connection status of the optical link that may affect the output of video quality rendered on a display sink side, such as a connection status between the optical link and a display source or a display sink forming a system that supports the HDMI (see FIG. 2) or the display port (see FIG. 1), an operating status of the optical link, and identification information of the optical link. The optical link corresponding to the diagnosis target from the diagnosis and monitoring system for implementing diagnosis and monitoring of the optical link according to an embodiment may transmit video auxiliary data including video data including video information, channel configuration data such as Display Port Configuration Data (DPCD) in relation to configuration of the main channel (or main lane) for the transmission of video data, and rendering configuration data such as Extended Display Identification Data (EDID) in relation to rendering of the display sink.

The FPGA block may be connected to the optical link corresponding to the diagnosis target of the diagnosis and monitoring system according to an embodiment, and the diagnosis and monitoring system may obtain diagnosis data generated from the FPGA block, for example, the diagnosis data including the status that may affect the output of video quality rendered on the display sink side, such as the connection status between the optical link and the display source or the display sink, the operating status (operating temperature and operating voltage) of the optical link, and the identification information of the optical link, and may transmit the diagnosis data to the administrator interface connected to the diagnosis and monitoring system over a communication network. For example, in an embodiment, the FPGA block (see FIG. 16) may include an FPGA control logic (programmable fabric) including an array of programmable logic blocks and performing processing according to a predefined process or logic, and memory RAM performing data read, write, update, etc. (e.g., create, read, update, and delete (CRUD)) in conjunction with the FPGA control logic, and may additionally include a multiplexer (see FIG. 17) for multiplexing the data processed according to the FPGA control logic, and a Serializer+Deserializer (SerDes) for converting parallel data processed according to the FPGA control logic into serial data or converting serial data transmitted from the display source, the display sink, or the FPGA block on the other side through the optical link into parallel data suitable for the processing of the FPGA block.

In an embodiment, the FPGA block may not be connected to the main channel (HDMI, see FIG. 2 or the main lane DP-Display Port, see FIG. 1) transmitting video data but may be connected onto a side channel (an auxiliary channel or DDC channel) for transmitting video auxiliary data including rendering configuration data such as EDID and channel configuration data such as DPCD, to perform a CRUD operation, such as storing video auxiliary data and diagnosis data in the memory RAM according to a process or logic configured in the FPGA control logic, updating the stored video auxiliary data and diagnosis data, or changing or modifying the video auxiliary data and diagnosis data or transmit the video auxiliary data and diagnosis data to the diagnosis and monitoring system according to an embodiment. Meanwhile, the diagnosis and monitoring system according to an embodiment may generate the diagnosis data including the status information of the optical link that may affect the output of video quality rendered on the display sink side, such as the connection status between the optical link and the display source or the display sink, the operating status of the optical link, and the identification information of the optical link. For example, the diagnosis and monitoring system according to an embodiment may generate diagnosis data from information about the connection status with the display source or display sink, such as hot plug detection (HPD) included in the video auxiliary data, the presence or absence of an output signal of the display source, and the presence or absence of an input signal of the display sink. For example, the FPGA block (see FIG. 16) may generate diagnosis data including the status information of the optical link including the connection status between the optical link and the display source or the display sink, the operating status of the optical link, and the identification information of the optical link itself from the video auxiliary data transmitted over the side channel (auxiliary channel or DDC channel) according to the process or logic configured in the FPGA control logic or, may generate diagnosis data by referring to other data (e.g., the presence or absence of the output signal of the display source, the presence or absence of the input signal of the display sink, etc.) transmitted from the display source or display sink, along with the video auxiliary data such as HPD. The process for generating such diagnosis data may include a request for the diagnosis data between a first FPGA block connected to the display source or a second FPGA block connected to the display sink and data communication between the first and second FPGA blocks, such as transmission of the requested diagnosis data (information about data communication between the first and second FPGA blocks may be included in the diagnosis data). For example, the first FPGA block or the second FPGA block may obtain the diagnosis data transmitted from the second FPGA block or the first FPGA block connected to the other side of the optical link and store the diagnosis data in its own memory RAM, and may transmit the diagnosis data stored in the memory RAM in response to a request from the diagnosis and monitoring system according to an embodiment. The diagnosis and monitoring system connected to the first FPGA block connected adjacent to the display source may also transmit diagnosis data regarding diagnosis data (e.g., the presence or absence of the output signal of the display source, etc.) mainly related to the display source such as the connection status between the display source connected adjacent to the first FPGA block and the optical link, as well as diagnosis data (e.g., the presence or absence of the input signal of the display sink, etc.) mainly related to the display sink such as the connection status between the display source connected adjacent to the other side of the first FPGA block and the optical link through communication between the first and second FPGA block. Similarly, the diagnosis and monitoring system connected to the second FPGA block connected adjacent to the display sink may also transmit diagnosis data regarding diagnosis data (e.g., the presence or absence of the input signal of the display sink, etc.) mainly related to the display sink such as the connection status between the display source connected adjacent to the second FPGA block and the optical link as well as diagnosis data (e.g., the presence or absence of the output signal of the display source, etc.) mainly related to the display source such as the connection status between the display source connected adjacent to the other side of the second FPGA block and the optical link through communication between the first and second FPGA block.

The optical link corresponding to the diagnosis target of the diagnosis and monitoring system according to an embodiment may include the FPGA block connected to the display source and the display sink. More specifically, the FPGA block may include the first FPGA block connected adjacent to the display source side and the second FPGA block connected adjacent to the display sink side. The main channel (or main lane) for transmitting video data including video information may be connected from the display source to the display sink without passing through the FPGA block.

For example, the FPGA block may be connected to the side channel (auxiliary channel or DDC channel) that is responsible for transmitting diagnosis data including video auxiliary data including the rendering configuration data related to the rendering performance of the display sink, such as EDID, or the channel configuration data related to the configuration of the main channel (or main lane), such as DPCD, and the status information of the optical link, such as the connection status between the display source and the display sink, the operating status of the optical link, and the identification information of the optical link itself. The FPGA block may be involved in the overall management of video auxiliary data, such as storing, changing, and transmitting the video auxiliary data, including the rendering configuration data and the channel configuration data (including requesting the video auxiliary data and transmitting the requested video auxiliary data in response thereto), such as changing the configuration of the main channel (or main lane) to be optimized for the optical link through link training for the configuration of the main channel (or main lane), storing the rendering configuration data, such as the rendering-related EDID of the display sink, or the channel configuration data, such as DPCD, for the configuration of the main channel (or main lane) for the transmission of video data, transmitting the stored rendering configuration data or channel configuration data, or changing the stored rendering configuration data or channel configuration data.

In an embodiment, the FPGA block may be involved in management of diagnosis data that may not be directly related to the configuration or management of the main channel (or main lane) for transmitting, for example, video data as the video auxiliary data, i.e., generating, storing, changing, and transmitting (e.g., including requesting the diagnosis data and transmitting the requested diagnosis data in response thereto) of the diagnosis data (e.g., diagnosis data including at least one of the status information exemplarily listed above) including the status information of the optical link, such as the connection status between the display source or the display sink and the optical link, the operating status of the optical link, and the identification information of the optical link itself. For example, the FPGA block may be involved in the overall management of diagnosis data, such as storing, changing, and transmitting the diagnosis data to provide diagnosis and monitoring of the connection status of the optical link, the operating status of the optical link, and the identification information of the optical link itself.

The diagnosis and monitoring system (see FIG. 3) according to an embodiment may be connected to a USB port of the FPGA block of the optical link or the optical communication module of the optical link including the FPGA block to diagnose and monitor the status information of the optical link (USB connection), and, for example, may form the USB connection with the diagnosis and monitoring system as a host and the FPGA block as a device. The diagnosis and monitoring system may transmit a request for diagnosis data with respect to the FPGA block on which a USB communication channel with the diagnosis and monitoring system is formed, receive the requested diagnosis data, and request update, modification, or change of diagnosis data. In an embodiment, the diagnosis and monitoring system (see FIG. 3) may form one-to-many parallel USB connections with a plurality of optical links (e.g., the FPGA block of each of the plurality of optical links) to provide diagnosis and monitoring of the plurality of optical links.

In an embodiment, the diagnosis and monitoring system may be connected to at least one of the first and second FPGA blocks connected adjacent to the display source side or the display sink side. For example, the diagnosis and monitoring system may be connected to the first FPGA block connected adjacent to the display source to obtain diagnosis data (e.g., the presence or absence of the output signal of the display source, etc.) mainly related to the display source such as the connection status between the display source connected adjacent to the first FPGA block and the optical link or may be connected to the second FPGA block connected adjacent to the display sink to obtain diagnosis data (e.g., the presence or absence of the input signal of the display sink, etc.) mainly related to the display sink such as the connection status between the display sink connected adjacent to the second FPGA block and the optical link. Then, the first FPGA block and the second FPGA block may be connected to each other via the optical link and perform data communication including the request for diagnosis data regarding the connection status between the optical link and the display source or the display sink connected adjacent to each of the first and second FPGA blocks and reception of the requested diagnosis data. Accordingly, the diagnosis and monitoring system may obtain both diagnosis data regarding the connection status between each display source and the optical link and the connection status between the display sink and the optical link even through connection with any one of the first and second FPGA blocks. For example, the diagnosis and monitoring system according to an embodiment may obtain diagnosis data mainly related to the display source, such as the connection status between the display source and the optical link, the presence or absence of the output signal of the display source, etc., and the diagnosis data mainly related to the display sink, such as the connection status between the display sink and the optical link, the presence or absence of the input signal of the display sink, etc. through the USB communication channel with the first FPGA block on the display source side, or through the USB communication channel with the second FPGA block on the display sink side.

For example, in an embodiment, the diagnosis and monitoring system may be connected to the first FPGA block to obtain both the diagnosis data regarding the connection status of the display source side (the connection status between the display source and the optical link) stored in the first FPGA block and the diagnosis data regarding the connection status of the display sink side (the connection status between the display sink and the optical link) stored in the second FPGA block from communication between the first and second FPGA blocks. Similarly, the diagnosis and monitoring system may be connected to the second FPGA block to obtain both the diagnosis data regarding the connection status of the display sink side (the connection status between the display sink and the optical link) stored in the second FPGA block and the diagnosis data regarding the connection status of the display source side (the connection status between the display source and the optical link) stored in the first FPGA block from communication between the first and second FPGA blocks.

In an embodiment, the FPGA block may store the diagnosis data including the video auxiliary data including the channel configuration data related to the configuration of the main channel (or main lane), such as DPCD and the rendering configuration data related to the rendering of the display sink, such as EDID, and the status information of the optical link including the connection status between the optical link and the display source or the display sink, the operating status of the optical link, and the identification information of the optical link itself. The FPGA block may store the latest data over time through update of data stored in the FPGA block in response to an environment change such as a change in the configuration environment of the main channel (or main lane) or a change in the status of the optical link.

The FPGA block (see FIG. 16, the first FPGA block or the second FPGA block) may obtain video auxiliary data or diagnosis data transmitted from a display source connected adjacent to the FPGA block or a display sink connected adjacent to the FPGA block, a display sink connected to the other side of the optical link or the second FPGA block adjacent to the display sink, or a display source connected to the other side of the optical link or the first FPGA block adjacent to the display source to read the obtained video auxiliary data or diagnosis data and process the read video auxiliary data or diagnosis data according to the process or logic configured in the FPGA control logic. For example, the FPGA block may read the video auxiliary data or the diagnosis data and store the video auxiliary data or the diagnosis data according to a predefined process or logic, or change or update the video auxiliary data or the diagnosis data. In addition, the FPGA block (the first FPGA block or the second FPGA block) may receive requests (e.g., read and write requests) of the FPGA block (second FPGA block or first FPGA block) transferred from the other side of the optical link, store the video auxiliary data or the diagnosis data according to the process or logic configured in the FPGA control logic (control logic of the first FPGA block or control logic of the second FPGA block) in the memory RAM, obtain the video auxiliary data or the diagnosis data requested from the memory RAM and transmit the obtained video auxiliary data or diagnosis data, or update the video auxiliary data or the diagnosis data stored in the memory RAM.

The FPGA block (see FIG. 16, the first FPGA block or the second FPGA block) may process diagnosis data according to the process or logic configured in the FPGA control logic at the request of the diagnosis and monitoring system in which the USB communication channel is configured with the FPGA block (or optical communication module including the FPGA block). For example, the FPGA block may generate diagnosis data including information about the connection status between the optical link and the display source or the display sink, the operating status of the optical link, and the identification information of the optical link itself, obtain the diagnosis data stored in the memory RAM of the FPGA block and transmit the diagnosis data to the diagnosis and monitoring system, request diagnosis data toward the FPGA block (the second FPGA block or the first FPGA block) connected to the display sink or the display source connected to the other side of the optical link and store the obtained diagnosis data in the memory RAM according to the transmission of the requested diagnosis data, or transmit the obtained diagnosis data to the diagnosis and monitoring system, by referring to the video auxiliary data (e.g., a HPD signal of the video auxiliary data) transmitted from the display source or display sink and/or other data (e.g., the presence or absence of the output signal of the display source, the presence or absence of the input signal of the display sink, etc.) transmitted from the display source or display sink, according to the request of the diagnosis and monitoring system.

For example, in an embodiment, each process or logic configured in the FPGA block (see FIG. 16) may be performed in parallel as an independent process or an independent sequence. The diagnosis data including the connection status of the optical link, the operating status of the optical link, and identification information of the optical link itself may be processed according to the independent logic or independent process and stored in the memory RAM. At the request from the diagnosis and monitoring system, the diagnosis data stored in the memory RAM of the FPGA block may be called from the independent logic or independent process as a process for responding or processing to the request of the diagnosis and monitoring system and transmitted to the diagnosis and monitoring system. As such, in an embodiment, each logic or process configured in the FPGA block (FPGA control logic) may be performed in parallel and independently of each other. For example, the diagnosis and monitoring system with the USB communication channel and the FPGA block (optical communication module including the FPGA block) may cooperate with each other to implement processing or management of the diagnosis data while implementing CRUD operations or transmission operation on the memory of the FPGA block.

A data transmission channel with each optical link may be formed, and a plurality of data transmission channels connected in parallel with the plurality of optical links may be formed in the diagnosis and monitoring system (FIG. 3) according to an embodiment so that the diagnosis and monitoring system may simultaneously diagnose and monitor connection statuses of the plurality of optical links, operating statuses of the plurality of optical links, and identification information of the plurality of optical links by obtaining diagnosis data of the connection statuses of the plurality of optical links, the operating statuses of the plurality of optical links, and the identification information of the plurality of optical links while forming a one-to-many connection with the plurality of optical links (FPGA block of each optical link or optical communication module including the FPGA block). In an embodiment, the diagnosis and monitoring system may include a plurality of USB host controllers forming one-to-one USB communication channels with each optical link (FPGA block of each optical link) on a plurality of data transfer channels, a UART-parallel converter connected to the plurality of USB host controllers to form a one-to-one UART communication channel with the USB host controllers, a single FPGA block forming a one-to-many parallel communication channel with the USB host controllers or the UART-parallel converter and connected in parallel with the plurality of USB host controllers or a plurality of UART-parallel converters to form the one-to-many connection, a single micro controller unit (MCU) forming a parallel communication channel with the FPGA block, and a communication module (Ethernet communication module) forming a parallel communication channel with the MCU. As described above, the data transmission channel formed in the diagnosis and monitoring system while passing through the configurations may be connected to the administrator interface from the communication module over a communication network.

For example, the diagnosis and monitoring system (see FIG. 3) may form a one-to-many USB connection with one USB host controller as a common host for a plurality of USB connections and the plurality of optical links connected to a USB hub capable of supporting the plurality of USB connections as devices, and alternatively also form a one-to-one USB connection with the plurality of multiple USB host controllers as hosts for the respective USB connections and each optical link as a device. The diagnosis and monitoring system (FIG. 3) according to an embodiment may include the plurality of optical links as devices of USB connections, and the plurality of USB host controllers as hosts of the respective USB connections. Accordingly, each USB connection may form a one-to-one USB connection with one optical link (a FPGA block of an optical link or an optical communication module including the FPGA block) as a device and each allocated USB host controller among the plurality of USB host controllers provided in the diagnosis and monitoring system as a host. Unlike in an embodiment, when the diagnosis and monitoring system includes only one single USB host controller to form a one-to-many USB connection with a plurality of optical links connected through a USB hub as devices, and the single USB host controller provided in the diagnosis and monitoring system as a host, the single USB host controller needs to perform a process for configuration of a USB communication channel against the plurality of optical links (FGPA blocks of optical links), respectively. For example, like configuration of (when supporting a dual role port (DRP)) a role such as a host (down facing port (DFP)) and a device (up facing port (UFP)) in relation to data transmission between the optical link and a device identifying connection of each USB port provided in the USB hub and connected to the USB port, or detection of pull-up resistor Rp (see FIG. 10) or pull-down resistor Rd (see FIG. 10) in relation to data transmission speed (LS: low speed, HS: high speed, FS: full speed), or configuration (when supporting the DRP) of the role such as the host (DFP) and the device (UFP) in relation to data transmission and/or a source or a sink in relation to charging, or baseband communication for power delivery configuration including charging power, a plurality of processes need to be performed to configure each communication channel between the single USB host and the plurality of optical links (FPGA block of each optical link) in the diagnosis and monitoring system. In the diagnosis and monitoring system including a structure forming a one-to-one USB connection in which a communication host involved in a plurality of processes for establishing each communication channel is limited to a single USB host controller, i.e., including a plurality of USB ports for a plurality of USB connections to a plurality of optical links (e.g., including connection of a USB hub including the plurality of USB ports) and a single USB host controller as the communication host of the USB connection, a time delay may occur in establishing the plurality of USB communication channels. In addition, when the USB connection is disconnected, a time delay may occur for retrieval and initialization of computational resources allocated for configuration of the USB communication channel (e.g., configuration of an initial level of the connection to the pull-up resistor Rp or the pull-down resistor Rd of Configuration Channel (CC), see FIG. 9, etc.) In addition, even when the USB communication channel is established, traffic for communication with the plurality of optical links (FPGA block of each optical link or optical communication module including the FPGA block) is concentrated on the single USB host controller, which may lead to a time delay in requesting diagnosis data with respect to the plurality of optical links or in the processing of the diagnosis data, such as receiving, storing, and changing the diagnosis data. As described above, from the limitation of the limited processing capacity of the single USB host controller in the diagnosis and monitoring system, when an event of USB connection/disconnection occurs, such as the configuration of a new USB communication channel according to the connection of a new optical link (FPGA block of optical link or optical communication module including the FPGA block) or recovery of the USB communication channel due to separation of a previous optical link (FPGA block of optical link or optical communication module including the FPGA block), a time delay may occur in operation processing, such as a request for diagnosis data for each optical link or processing of diagnosis data received from each optical link. From this consideration, in the diagnosis and monitoring system (see FIG. 16) according to an embodiment, while simultaneously performing diagnosis and monitoring on status information of a plurality of optical links including connection statuses of the plurality of optical links (connection statuses between the optical link and the display source and the optical link and the display sink), the operating statuses of the plurality of optical links, and identification information of the plurality of optical links, as communication hosts for USB connections with the plurality of optical links, by providing USB host controllers in the same number as the optical links forming the respective USB communication channels (one-to-one connection between the optical link and the USB host controller), no time delay may occur in the transmission and reception of diagnosis data or the processing of diagnosis data with regard to the configuration of the USB communication channel of each optical link or recovery of the configured USB communication channel. For example, a dedicated USB host controller allocated to each optical link may distribute and process the traffic of the USB communication channel with the plurality of optical links (FPGA block of each optical link or optical communication module including the FPGA block), and thus, no time delay may occur in the processing of diagnosis data including information about the connection statuses of the plurality of optical links.

In an embodiment, a plurality of data transmission channels formed parallel to each other in the diagnosis and monitoring system (see FIG. 16) may be connected in parallel to a single FPGA circuit in the diagnosis and monitoring system through each USB host controller that functions as a communication host for USB connections with each optical link so as to form a flow of diagnosis data of the connection status of each optical link or a control signal (or a control command) for processing the diagnosis data. The flow of diagnosis data of each optical link transmitted along each data transmission channel or control signal (control command) for processing the diagnosis data may be processed in parallel in the FPGA circuit. For example, the FPGA circuit (see FIG. 5) may include an FPGA control logic (programmable fabric) including an array of programmable logic blocks and performing processing according to a predefined process or logic, and the memory RAM performing data read, write, update, etc. (e.g., create, read, update, and delete (CRUD)) in conjunction with the FPGA control logic, and may be advantageous for parallel tasks compared to an MCU connected to the FPGA circuit along a data transmission channel. For example, the FPGA circuit may perform parallel operations such as input/output of diagnosis data or control flow for processing the diagnosis data through a plurality of data transmission channels. The plurality of data transmission channels formed in parallel within the diagnosis and monitoring system to form individual connection channels with the plurality of optical links (FPGA block of each optical link) may be connected in parallel to the FPGA circuit (see FIG. 5) and formed as a single connection channel between the FPGA circuit and the MCU. In other words, the data transmission channel through which input/output data of the plurality of optical links is transmitted may be formed as a separate connection channel for each optical link between the plurality of host controllers and the FPGA circuit (see FIG. 5), and may be formed as the single connection channel between the FPGA circuit and the MCU.

As described below, unlike the FPGA circuit, the MCU may support serial processing and support multi-processing in a TDM method. For example, the flow of diagnosis data of the plurality of optical links connected to the diagnosis and monitoring system or the control signal for processing the diagnosis data may be processed in parallel in the FPGA circuit, and the flow of diagnosis data of the FPGA circuit or the control signal for processing the diagnosis data may be time-division multi-processed in the MCU of serial processing. Accordingly, in an embodiment, the data transmission channel formed in the diagnosis and monitoring system (see FIG. 3) may be formed as a parallel connection channel from USB connections with the plurality of optical links to the FPGA circuit (see FIG. 5) of parallel processing, and may be formed as a single connection channel from the FPGA circuit to the MCU of serial processing.

The FPGA circuit (see FIG. 5) may include an FPGA control logic (programmable fabric) including an array of programmable logic blocks and performing processing according to a predefined process or logic, and the memory RAM performing data read, write, update, etc. in conjunction with the FPGA control logic. The FPGA circuit may further include the multiplexer MUX (see FIG. 5) for multiplexing the plurality of data transmission channels connected in parallel to the FPGA circuit or for multiplexing (e.g., TDM) data that is input/output through the plurality of data transmission channels connected in parallel to the FPGA circuit. For example, in an embodiment, the FPGA circuit (see FIG. 5) may include the multiplexer MUX (see FIG. 5) for implementing TDM so that data that is input/output through the plurality of data transmission channels connected in parallel to the FPGA circuit may be transmitted through a single connection channel, that is, a single connection channel formed between the FPGA circuit and the MCU. Accordingly, diagnosis and monitoring of the connection statuses of the plurality of optical links connected to the diagnosis and monitoring system (see FIG. 3) according to an embodiment may be implemented by multi-processing of TDM on each optical link forming the plurality of optical links, and may be implemented by time-division multi-processing of the MCU for controlling the overall operation of the diagnosis and monitoring system according to an embodiment. For example, the MCU may generate a control signal (control command) for controlling the overall operation of the diagnosis and monitoring system at a request from the management interface connected to the diagnosis and monitoring system over a communication network, and transmit the generated control signal toward an optical link that is the target of the control signal, and, in response thereto, obtain diagnosis data transmitted from the corresponding optical link and transmit the diagnosis data to the management interface connected to the diagnosis and monitoring system over the communication network. As described above, the MCU may form a flow of input/output of data, such as transmission of the control signal including a data request for each optical link or reception of requested data, through the data transmission channel, and may process tasks related to the respective optical links through time-division multi-processing through the multiplexer MUX (see FIG. 5) of the FGPA circuit in which the plurality of data transmission channels are connected in parallel. For example, in an embodiment, the multiplexer MUX (see FIG. 5) of the FPGA circuit may multiplex connection channels with first to Nth optical links or data that is input and output through the connection channels with the first to Nth optical links through TDM time slots. For example, the multiplexer may sequentially process tasks related to the first to Nth optical links while sequentially inputting and outputting data through the connection channel with each optical link from the first optical link to the Nth optical link according to a control signal (a control signal synchronized to a clock) applied to the multiplexer MUX (see FIG. 5) (MCU: time-division multi-processing).

In an embodiment, multiplexing the connection channels with first to Nth optical links connected to the diagnosis and monitoring system or the data that is input and output through the connection channels with the first to Nth optical links may mean, for example, when an optical link among the first to Nth optical links is switched from a connection status to a disconnection status, implementing asynchronous time division multiplexing (ATDM, see FIG. 6A) that allocates a time slot allocated to the disconnected optical link to the other optical link. For example, even when an optical link (second optical link) among the first to Nth optical links is switched from the connection status to the disconnection status, multiplexing may not correspond to synchronous time division multiplexing (STDM, see FIG. 6B) that empties a time slot allocated to data that is input/output through a connection channel of the second optical link or stuffs the time slot with a stuffing symbol. For example, in an embodiment, from ATDM (see FIG. 6A), the diagnosis and monitoring system sequentially performing tasks related to, for example, the first to Nth optical links or the MCU (see FIG. 5) for controlling the overall operation of the diagnosis and monitoring system may detect that the second optical link among the first to Nth optical links has been switched from a connection status to a disconnection status, and may allocate a time slot allocated to data that is input/output through a connection channel of the second optical link to another optical link. The MCU sequentially performing the tasks related to the first to Nth optical links may perform, for example, a task related to the first optical link and skip directly to a task related to a third optical link, without performing a task related to the disconnected second optical link. As described below, the USB host controller (see FIG. 4) forming a host of the USB communication channel with each optical link (FPGA block of each optical link or optical communication module including the FPGA block) may switch an output of a GPIO pin to a high/low signal according to the connection/disconnection status of the optical link forming each USB communication channel. The MCU that has detected a change in the output level of the GPIO pin of the USB host controller (see FIG. 4) may initiate a reset operation on the USB host controller of which output level has been switched, control the FPGA circuit (e.g., the multiplexer MUX of the FPGA circuit, see FIG. 5) not to allocate a time slot for TDM to a data transmission channel connected to the USB host controller (see FIG. 4) of which output level has been switched, and allocate a time slot corresponding to another data transmission channel (ATDM, see FIG. 6A). Accordingly, the MCU may skip to the next optical link without performing a task related to the optical link with the USB connection disconnected, thereby preventing waste of computation time for the disconnected optical link in multi-processing performed in a TDM method and processing a task related to another optical link that maintains a connection status as quickly as possible.

Each configuration connected to the data transmission channel in the diagnosis and monitoring system (see FIG. 3) according to an embodiment of will be described as follows. The MCU may include an arithmetic and logical unit (ALU) for arithmetic and logical operations and a cache or register for temporary storage of variables input and output to and from the ALU, and unlike the FPGA block (FPGA control logic) independently or in parallel processing a predefined process or logic, may support time-division multi-processing such as multi-threads while supporting serial processing. For example, the MCU may be advantageous for sequential or serial tasks, and include a relatively small number of cores to handle difficult and small amount of calculations quickly, whereas the FPGA circuit (see FIG. 5) may be advantageous for parallel tasks and handle relatively simple and large amounts of calculations quickly. For example, in an embodiment, the MCU may function as a central processing unit or central control unit capable of controlling the overall operation of the diagnosis and monitoring system. For example, the MCU may follow a control command received from an administrator terminal through a communication module and transmit the control command (control signal) including data such as Data, Address, Write, and Read to the FPGA circuit (see FIG. 5), for example, may output a control command including a target address (Device Address) which is the target of the control command among the plurality of optical links, write/read mode designation (Write, Read), and data (Data) to the FPGA circuit, and transmit a control command with respect to the MCU through a parallel communication channel.

The FPGA circuit (see FIG. 3) may request diagnosis data such as a connection status of an optical link, an operating status of the optical link, and identification information of the optical link, or receive the requested diagnosis data, or request CRUD (create, read, update, delete) operations of diagnosis data such as change or modification of diagnosis data, with respect to the optical link (e.g., optical link specified according to an address of a control command, e.g., Target Address or Device Address) specified according to the control command among the plurality of optical links connected to the diagnosis and monitoring system according to a process or logic configured in the FPGA control logic called according to the control command (control signal) of the MCU.

The FPGA circuit (see FIG. 3) may transmit a control signal following a control command from the MCU to a UART-parallel converter through a parallel communication channel, and the UART-parallel converter may convert parallel data into UART communication data, which is serial data, and, for example, form a UART communication channel, which is an asynchronous serial communication, so that a separate clock signal may not be accompanied, and data reading may be possible from a baud rate specified by the communication protocol and a start bit (e.g., bit 0) and a stop bit (e.g., bit 1).

The USB host controller (see FIG. 3) may function as a host for a USB connection with each optical link (FPGA block of each optical link or optical communication module including the PGA block) as a device in USB connections formed with the plurality of optical links, UART communication data transmitted from the UART-parallel converter through the USB host controller may be converted into USB communication data and transmitted to an optical link connected via USB, and conversely, the USB communication data from the optical link connected via USB through the USB host controller may be converted into the UART communication data and transmitted to the UART-parallel converter.

More specifically, the USB host controller (see FIG. 4) may include a UART interface for readjusting a data structure such as format, coding, signal level, order, etc. of data following a UART communication protocol, control information such as interpretation of the corresponding signal pattern and transmission control and error correction according to the interpretation, and timing such as speed adjustment between communication hosts, transmission time of a message, and transmission order, to a data structure following the USB communication protocol, control information, and timing, and conversely, a USB interface for readjusting a data structure following the USB communication protocol, control information, and timing, to a data structure following the UART communication protocol, control information, and timing. The USB host controller may perform a process for readjusting a data structure, control information, and timing between different communication protocols.

For example, the USB host controller may generate and execute two different threads each including a main function and provided with an execution environment within the same process (see FIGS. 12 and 13). In a process providing an execution environment for two different threads, the two different threads may share a code area, a data area, and a heap area of memory, while a stack area may be individually allocated to each thread.

For example, two different threads (see FIG. 4) may include a thread (UART interface) for converting UART communication data following the UART communication protocol to USB communication data following the USB communication protocol, and conversely, a thread (USB interface) for converting USB communication data following the USB communication protocol to UART communication data following the UART communication protocol. For example, these different threads (UART interface and USB interface, see FIG. 4) may be executed independently of each other. The threads (UART interface and USB interface, see FIG. 4) for USB-UART conversion may convert UART communication data or USB communication data that is input to the USB host controller (see FIG. 4) into USB communication data or UART communication data in a unit in which error detection or error correction is defined (e.g., data frame unit or a series of entire continuous signals: for example, a series of entire continuous signals transmitted continuously from one end forming a communication host toward the other end forming a communication host). When conversion occurs in the middle of the unit in which error detection or error correction is defined (e.g., data frame unit or a series of entire continuous signals: for example, a series of continuous signals transmitted continuously from one end forming the communication host toward the other end forming the communication host), because the UART communication data or USB communication data may be converted into a signal including an error and transmitted to the next stage before error detection or error correction, the conversion of UART-USB may be performed at least in the unit capable of error detection or error correction (e.g., data frame unit or a series of entire continuous signals: for example, a series of entire continuous signals transmitted continuously from one end forming the communication host toward the other end forming the communication host).

Contrary to the thread (UART interface, see FIG. 4) for converting UART communication data as input into USB communication data on the data transmission channel from the MCU or FPGA circuit to the optical link connected via USB, the thread (USB interface, see FIG. 4) for converting USB communication data as input into UART communication data on the data transmission channel from the USB-connected optical link to the MCU or FPGA circuit may be executed independently of each other. Two different threads (UART interface and USB interface) share the code area where a function is stored, the data area where a global variable is stored, and the heap area allocated as dynamic memory, and individually allocating the stack area where a local variable or a function parameter of the function is stored for each thread in the same process providing an execution environment (see FIG. 12). As described above, different threads (UART interface and USB interface, see FIG. 4) may be executed independently of each other, but, for example, global variables of the connection/disconnection status of the optical link are stored in the shared data area (see FIG. 12) so that information about the connection/disconnection status of the optical link may be shared between different threads (the UART interface and the USB interface, see FIG. 4). For example, the information about the connection/disconnection status shared between different threads may be detected from the output level of the GPIO pin (see FIG. 4) of the USB host controller as a communication host forming the USB connection with the optical link, for example, the USB host controller forming the USB connection with each optical link may switch the output level of the GPIO pin to a high/low signal according to switching of the connection/disconnection status of each optical link, the change in the output level of the GPIO pin of the USB host controller may be detected by the MCU, a reset operation of the USB host controller may be initiated by the control of the MCU, and global variables of the connection/disconnection status of the optical link shared between the threads (UART interface and USB interface) executed in the USB host controller may be changed.

In an embodiment, by allowing different threads (UART interface and USB interface) executed in the USB host controller (see FIG. 4) to execute independently of each other, errors due to collisions between these different threads, for example, collisions between functions, libraries, variables, etc. of different threads, may be fundamentally prevented. For example, the threads (the UART interface and the USB interface, see FIG. 4) for the UART-USB conversion may be executed independently of each other, and may convert the UART communication data or the USB communication data that is input to the USB host controller (see FIG. 4) into the USB communication data or the UART communication data in the unit in which error detection or error correction is defined, or in the series of entire continuous data units (entire units received to the last byte) transmitted from one end to the other end between communication hosts. When UART-USB conversion occurs in the middle of the unit in which error detection or error correction is defined or in the series of entire continuous data units (entire units received to the last byte) transmitted from one end to the other end between communication hosts, because the UART communication data or USB communication data may be converted into data including an error and transmitted to the next stage (optical link or UART-parallel converter, see FIG. 3) before error detection or error correction of UART communication data or USB communication data, the UART-USB conversion may be performed in the unit capable of error detection or error correction (e.g., data frame unit) or in the series of entire continuous data units (entire units received to the last byte) transmitted from one end to the other end between communication hosts. For example, in an embodiment, rather than UART-USB conversion is performed in the data frame unit capable of error detection or error correction, a cross-conversion operation may be performed only after receiving the entire data to the last byte as the series of entire continuous data units transmitted from one end to the other end between the communication hosts (UART-parallel converter and USB host controller or optical link and USB host controller).

The USB host controller (see FIG. 4) may manage a USB connection with the USB host controller itself as a host and the optical link as a device (FPGA block of each optical link or optical communication module including the FPGA block) forming the USB connection with the diagnosis and monitoring system including the USB host controller. For example, the USB host controller may detect the USB connection of the optical link and output the USB connection/disconnection status of the optical link through a separate general purpose IO (GPIO) pin. For example, in an embodiment, the USB host controller may output the output of the GPIO pin as a high signal in a USB connection status of the optical link, and may output the output of the GPIO pin as a low signal in a USB disconnection status of the optical link. As described above, by switching the output of the GPIO pin of the USB host controller to the high/low signal according to the switching of the USB connection/disconnection status, the MCU that has detected the switching of the output of the GPIO pin of the USB host controller may initiate a reset operation on the USB host controller that has detected the switching of the output of the GPIO pin. For example, in an embodiment, as the reset operation of the USB host controller is initiated by the control of the MCU, the USB host controller may perform initialization for USB connection. For example, the USB host controller may connect Configuration Channel (CC) (CC1, CC2, see FIG. 9) to the pull-up resistor (Rp, see FIG. 10) so as to be role-determined as the host (DFP) according to the USB connection, and, for example, during the initialization of the USB host controller, perform initialization for setting the output level of the USB host controller. For example, in various embodiments, the CC (Configuration Channel, CC1, CC2, see FIG. 9) of the USB host controller may perform baseband communication (e.g., peak-to-peak 1.1 V) for configuring a USB communication channel, may also be connected to V_{CONN} to supply power to a device such as an Electronically Marked IC (EMIC), may output an output level different from that in the status of being connected to the pull-up resistor (Rp, see FIG. 10) for detection of an initial connection status or an initial role determination during the USB connection of an optical link. For detection of the connection status in a future USB connection and the role determination between USB communication hosts through the initialization of the USB host controller, for example, the USB host controller may perform initialization of the output level such as connecting the CC (CC1, CC2, see FIG. 9) of the USB host controller to the pull-up resistor (Rp, see FIG. 10) so as to be role-determined as the host (DFP).

For example, in an embodiment, the reset operation of the USB host controller may include setting the output level of the GPIO pin of the USB host controller (see FIG. 4), and generating different threads for UART-USB conversion, for example, generating a thread (UART interface, see FIG. 4) for conversion from UART communication data to USB communication data and a kernel object for managing the thread, generating a thread (USB interface, see FIG. 4) for conversion from USB communication data to UART communication data and a kernel object for managing the thread, and executing the generated threads (UART interface and USB interface, see FIG. 4).

In an embodiment, the USB host controller (see FIG. 4) may detect a USB connection of an optical link and switch the output level of the GPIO pin to a high signal. The above USB host controller may The USB host controller may detect the USB connection (e.g., by detecting the connection of the counterpart device via CC) and, through device emulation of the optical link (FPGA block of the optical link) of which USB connection has been detected, determine whether the USB device (optical link) whose USB connection is detected is a predefined optical link. More specifically, the USB host controller may identify a vendor ID (VID) as a 16-bit identification mark for identifying a manufacturer and a product ID (PID) as a 16-bit identification mark for identifying a product of the manufacturer, as identification marks allocated to the corresponding USB device (optical link) through device emulation, may emulate a connected USB device (optical link) from a combination of the VID and PID, and may determine whether the USB device is the predefined USB device (optical link). In an embodiment, when the USB host controller detects the connection of the USB device and determines that the USB device emulated through the combination of VID and PID obtained through device emulation of the USB device of which USB connection has been detected corresponds to the predefined or pre-set optical link, the USB host controller may output the output of the GPIO pin (see FIG. 4) of the USB host controller as a high signal indicating a connection status. In contrast, when the USB host controller detects the connection of the USB device, but determines that the USB device emulated through the combination of VID and PID obtained through device emulation of the detected USB device does not correspond to the predefined or pre-set optical link, the USB host controller may output the output of the GPIO pin (see FIG. 4) of the USB host controller as a low signal indicating a disconnection status despite the detection of the USB connection.

In various embodiments, the diagnosis and monitoring of the connection status through the diagnosis and monitoring system needs to be a USB device that follows a predefined rule or protocol for smooth communication with the diagnosis and monitoring system. For example, like the USB device produced by the same manufacturer as the diagnosis and monitoring system, the diagnosis and monitoring needs to follow preset rules with respect to a data structure such as format, coding, signal level, order, etc. of data following a UART communication protocol, control information such as interpretation of the corresponding signal pattern and transmission control and error correction according to the interpretation, and timing such as speed adjustment between communication hosts, transmission time of a message, and transmission order. For example, even the USB device produced by the same manufacturer as the diagnosis and monitoring system needs to block connections with other USB devices other than the optical link, in consideration of the connection with the diagnosis and monitoring system for diagnosis and monitoring of the connection status of the optical link. In consideration of the above, the diagnosis and monitoring system according to an embodiment may detect the USB connection, may read the identification marks of VID and PID from device emulation of the USB device of which USB connection has been detected, may determine whether the emulated USB device corresponds to the predefined USB device or the pre-set USB device based on a combination of the read VID and PID, may output the output of the GPIO pin (see FIG. 4) of the USB host controller as a high/low signal based on a result of determination, and may perform diagnosis and monitoring on the optical link connected via USB by the MCU that has detected the output of the GPIO pin (see FIG. 4) of the USB host controller.

In an embodiment, data and power may be supplied together through a USB connection according to a USB type supported by the diagnosis and monitoring system (see FIG. 3), for example, power supply may be possible together with data communication between the diagnosis and monitoring system forming the USB connection and the optical link, and, for example, driving power of the optical link (FPGA block of the optical link or optical communication module including the FPGA block) may be supplied from the diagnosis and monitoring system connected to the commercial system. At this time, in response to a request (power off request) for power cutoff of the optical link (together with the Target Address or Device Address of the optical link to be power off) received through the management interface connected through the communication network, the MCU may control the USB host controller to cut off the driving power of the optical link from the USB host controller. At this time, the USB host controller may switch the status of connection/disconnection with the optical link that is the target of power cutoff, and accordingly, may switch the output level of the GPIO pin (see FIG. 4) of the USB host controller to a high/low signal, and the MCU that has detected the change in the output level of the GPIO pin of the USB host controller may initiate the reset operation of the USB host controller. In an embodiment, the reset operation of the USB host controller may be initiated in response to a disconnection of the optical link connected via USB and an event of power cutoff from the USB host controller in response to a request from the administrator interface (see FIG. 3) received from a communication network, the USB host controller may be initialized in response to the reset operation of the USB host controller, and a USB communication channel with the optical link may be re-configured as the USB connection is detected again after the reset operation in response to the disconnection of the USB-connected optical link. As power supply is initiated after the reset operation due to power cut from the USB host controller, for example, as the request (power on request) is received from the administrator interface over the network, power supply from the USB host controller is initiated, and thus, the USB communication channel with the optical link may be configured again. At this time, configuring the USB communication channel with the optical link again may mean processing a flow of data that is input/output through the data transmission channel from the optical link to which the USB connection channel is configured by the MCU that has detected a change in the output level of the GPIO pin of the USB host controller (see FIG. 4), and may mean multiplexing the flow of data that is input/output through the data transmission channel from the optical link to which the USB connection channel is configured along with other data transmission channels through the multiplexer (MUX, see FIG. 5) of the FPGA circuit by the control of the MCU, and processing tasks related to the corresponding optical link. In various embodiments, the diagnosis and monitoring system (see FIG. 3) may power off by cutting off power supply from the USB host controller to the optical link in response to a request (control command) from the administrator interface transmitted over the communication network, or may power off in response to a control signal transmitted to the optical link along a data transmission channel (e.g., the USB host controller cuts off power supplied to the optical link connected via USB in response to the request transmitted from the administrator interface over the communication network). For example, the MCU that has transmitted a control signal to power off the optical link toward the USB host controller in response to a request from the administrator interface transmitted over the communication network may initiate the reset operation on the USB host controller or the USB host controller may switch the output level of the GPIO pin (see FIG. 4) when no connection is detected from the USB connected optical link according to cut off of power supply from the USB host controller to the optical link. The MCU that has detected the change in the output level may initiate the reset operation of the USB host controller.

In an embodiment, in order to prevent tasks related to the optical link to which USB connection is interrupted from being performed according to switching of USB connection/disconnection with the optical link, and in order to prevent tasks related to the optical link to which power supply is interrupted from being performed according to the request (power off request) received from the administrator interface over the communication network, the output level of the GPIO pin of the USB host controller forming the communication host of the USB connection may be detected through the MCU that controls the overall operation of the diagnosis and monitoring system. The MCU that has detected the change in the output level of the GPIO pin of the USB host controller may initiate the reset operation of the USB host controller and block the flow of input/output of data related to the optical link where the USB is disconnected or the power supply is interrupted from the USB host controller. As the flow of data input/output from the USB host controller is interrupted, while allocating the time slot allocated to the data transmission channel where data input/output is interrupted to data that is input/output through the data transmission channel with the remaining optical links connected via USB through ATDM via the multiplexer (MUX, see FIG. 5) of the FPGA circuit, the MCU connected to the FPGA circuit may be prevented from performing tasks related to the optical link where the USB is disconnected or the power supply is interrupted. For example, in an embodiment, errors of data processing may be fundamentally prevented through the reset operation of the USB host controller forming the USB communication channel for data input/output with the optical link while forming the USB connection with the optical link. By resetting the USB host controller that transmits and receives input/output data directly toward the optical link (FPGA block of the optical link or optical communication module including the FPGA block) while forming the USB connection with the optical link, erroneous transmission of data and erroneous processing of data through the data transmission channel formed within the diagnosis and monitoring system may be prevented.

The communication module (see FIG. 3) may receive requests (control commands) including Read, Write, Address, Data, etc. transmitted from the administrator interface connected via an Ethernet communication network, and may transmit diagnosis data including at least one of the connection status of the plurality of optical links connected via USB to the diagnosis and monitoring system, the operating statuses of the optical links, or identification information about the optical links to the administrator interface over the communication network. For example, in an embodiment, the diagnosis and monitoring system (see FIG. 3) may extract an access address of the administrator interface included in a header of an IP packet including a request (control command) of the administrator interface received over a communication network, and may transmit requested data (e.g., diagnosis data including at least one of a connection status of an optical link, an operating status of the optical link, or identification information about the optical link) by referring to the extracted access address of the administrator interface. For example, in various embodiments, the communication module (see FIG. 3) may transmit various status information about the optical link connected via USB to the diagnosis and monitoring system according to the request (control command) of the administrator interface transmitted over the communication network. As described above, in addition to the status information that may affect the video quality rendered on the display sync side, as information about the connection status of the optical link, the communication module (see FIG. 3) may obtain various status information about the optical link, including identification information about the optical link, such as a model name of the optical link and a product serial number of the optical link, the operating status of the optical link, such as an operating voltage and operating temperature, from the corresponding optical link (FPGA block of the optical link) and transmit the information to the administrator interface over the communication network.

For example, an administrator that has identified the status of the optical link through the administrator interface (see FIG. 3) connected over the communication network or the administrator interface may transmit a request (control command) to change the status of the optical link to the diagnosis and monitoring system, and the communication module may receive a request (control command) from the administrator interface to control an operation of the optical link, such as power on/off of the optical link connected via USB to the diagnosis and monitoring system. For example, in an embodiment, the MCU that has received the request (control command) for power off of the optical link from the administrator interface may transmit a control signal for power off toward the USB host controller connected to the corresponding optical link, and the USB host controller may power off the corresponding optical link while cutting off power supply to the corresponding optical link. In contrast, the MCU that has received a request (control command) for power on of the optical link from the administrator interface may transmit a control signal for power on toward the USB host controller connected to the corresponding optical link, and the USB host controller may power on the corresponding optical link while initiating power supply to the corresponding optical link. At this time, the USB host controller may not detect the connection status of the optical link according to the interruption of power supply or the initiation of power supply, or may detect the connection status of the optical link, and may switch the output of the GPIO pin (see FIG. 4) of the USB host controller to high/low according to whether the connection status of the optical link is detected.

In an embodiment of, the diagnosis and monitoring system may perform diagnosis and monitoring on various status information about a plurality of optical links, such as status information that may affect the video quality rendered on the display sync side as information about the connection status with a display source or a display sink, the operating statuses of the optical links such as the operating voltages and operating temperatures of the optical links, and the identification information about the optical links, as status information about plurality of optical links. In this sense, in an embodiment, the diagnosis data that may be monitored and managed through the diagnosis and monitoring system may comprehensively mean information about the connection status with the display source or display sink status (e.g., status information that may affect the video quality rendered on the display sync side, like whether there is an output signal on the display source side and whether there is an input signal on the display sink side), the operating statuses of the optical links such as the operating voltages or operating temperatures, and the identification information about the optical links itself such as model names or serial numbers of the optical links, as information about various statuses of the optical links. In an embodiment, the diagnosis and monitoring system may provide diagnosis and monitoring and management of video auxiliary data including at least one of channel configuration data related to channel configuration of a main channel (or main lane) for transmission of video data between the display source and the display sink and rendering configuration data related to rendering performance of the display sink, along with monitoring and management of diagnosis data. For example, the diagnosis and monitoring system may provide monitoring and management of video auxiliary data including channel configuration data related to channel configuration of main channel (or main lane) such as DPCD and rendering configuration data related to rendering of display sink such as EDID. More specifically, the diagnosis and monitoring system may provide monitoring and management of video auxiliary data, such as requesting the video auxiliary data for each optical link (FPGA block of the optical link), receiving the requested video auxiliary data, and changing the video auxiliary data. For example, through requesting, receiving and changing channel configuration data related to the channel configuration of the main channel (or main lane) requested from the administrator interface, the administrator interface or administrator may identify the channel configuration data regarding the currently configured channel configuration, for example, an emphasis level (pre-emphasis level or de-emphasis level) of the signal pattern transmitting video data and a swing level related to a peak-to-peak voltage, and request a change to other channel configuration data optimized for the optical link (e.g., requesting a change to channel configuration data optimized for the optical link in case of link training failure). Through requesting, receiving and changing rendering configuration data requested from the administrator interface, the administrator interface or administrator may identify the rendering configuration data related to the rendering performance of the currently configured display sink, such as the resolution and refresh rate, and request a change to other rendering configuration data optimized for the display sink (e.g., changing rendering performance, such as resolution and refresh rate, to improve the video quality of the display sink).

In an embodiment, the UART-parallel converter (see FIG. 3) may convert parallel communication data transmitted from the FPGA circuit into UART communication data and transmit the UART communication data to the USB host controller, and conversely, convert the UART communication data transmitted from the USB host controller into the parallel communication data and transmit the parallel communication data to the FPGA circuit. At this time, the UART-parallel converter may identify the output level of the GPIO pin of the USB host controller (see FIG. 4) and, according to the output level, may not perform UART-parallel conversion on data that is input/output through a data transmission channel connected to the corresponding USB host controller. For example, when the output level of the GPIO pin of the USB host controller (see FIG. 4) is switched to a low signal level indicating the disconnection of the optical link connected via USB, the UART-parallel converter (see FIG. 3) may not perform UART-parallel conversion on data that is input/output through a data transmission channel to which the USB host controller of which output level has been switched to the low signal level is connected. In an embodiment, the diagnosis and monitoring system (see FIG. 3) may include a plurality of UART-parallel converters connected to the respective data transmission channels. Each UART-parallel converter may identify the output level of the GPIO pin (see FIG. 4) of the USB host controller connected to its own data transmission channel. For example, each UART-parallel converter (see FIG. 3) may identify the output level of the GPIO pin (see FIG. 4) of the USB host controller connected to its data transmission channel at preset periodic intervals. The UART-parallel converter (see FIG. 3) in which the GPIO pin of the USB host controller connected to its own data transmission channel outputs a high signal may perform UART-parallel conversion, but the UART-parallel converter (see FIG. 3) in which the GPIO pin of the USB host controller connected to its own data transmission channel outputs a low signal may not perform UART-parallel conversion. In various embodiments, the UART-parallel converter (see FIG. 3) connected to each data transmission channel may identify the output level of the GPIO pin of the USB host controller connected to its own data transmission channel and may perform UART-parallel conversion or not perform UART-parallel conversion according to identified the output level of the GPIO pin or may perform UART-parallel conversion or not perform UART-parallel conversion according to the output level of the GPIO pin of the USB host controller connected to each data transmission channel by the control of the MCU that has identified the output level of the GPIO pin of the USB host controller connected to each data transmission channel. At this time, the UART-parallel converter and/or MCU may identify the output level of the GPIO pin (see FIG. 4) of the USB host controller connected to each data transmission channel at a preset periodic interval, and a conversion operation of the UART-parallel converter connected to each data transmission channel may or may not be performed according to the output level of the GPIO pin of the USB host controller connected to each data transmission channel. In other words, the UART-parallel converter (see FIG. 3) connected to each data transmission channel may or may not perform a UART-parallel conversion operation according to the output level of the GPIO pin of the USB host controller connected to its own data transmission channel.

In an embodiment of, a turn-on process of the diagnosis and monitoring system may include an initialization process for each component connected to a data transmission channel of the diagnosis and monitoring system, for example, in the initialization of the UART-parallel converter (see FIG. 3) connected to each data transmission channel, a communication channel of the UART may be configured, and a baud rate, data bit, stop bit, parity bit, etc. of the UART communication channel may be configured. For example, in an embodiment, the UART communication channel may be configured to a baud rate of 115200 bps, data bit: 8 bits, non-parity bit, and one stop bit.

The communication module (see FIG. 3) may transmit diagnosis data transmitted from each optical link to the administrator interface over a communication network or receive requests including Read, Write, Address, Data, etc. transmitted from the administrator interface over the communication network. For example, in the initialization of the communication module, an Ethernet communication network may be set through User Datagram Protocol (UDP), and network information such as an IP address, Sub Mask, Gateway, and MAC Address may be set. In addition, the USB host controller (see FIG. 3) may perform reset (hardware reset), and the initialization of the USB host controller according to the reset operation may be performed according to a firmware design. However, in various embodiments, the communication module may also set an Ethernet communication network through a Transmission Control Protocol (TCP).

The diagnosis and monitoring system according to an embodiment may provide diagnosis and monitoring of the optical link, and the optical link that is a target of diagnosis and monitoring of the diagnosis and monitoring system according to an embodiment may form the main channel (or main lane) for transmitting video data between the display source and the display sink, and the side channel for transmitting video auxiliary data including channel configuration data related to channel configuration of the main channel and rendering configuration data related to rendering configuration of the display sink, and diagnosis data related to status information about the optical link.

In an embodiment, the optical communication module may be connected between the display source or the display sink, and the optical communication module may include the optical transmission module (FIG. 14A) connected to the display source side and the optical reception module (FIG. 14B) connected to the display sink side. In addition, the optical communication module may include the FPGA block described above (see FIG. 16), and together with the FPGA block, may include a photoelectronic conversion element that implements a photoelectronic conversion between an electrical signal and an optical signal.

The photoelectric conversion element (see FIGS. 14A and 14B) is for implementing modulation between an electrical input/output signal and an optical input/output signal, and may include a light-emitting element for converting an electrical signal into an optical signal and transmitting the optical signal through an optical link (optical fiber of the optical link), and a light-receiving element for converting the optical signal received through the optical link (optical fiber of the optical link) into the electrical signal.

In an embodiment, the photoelectric conversion element for implementing photoelectric conversion on video data may be connected onto the main channel (or main lane) for transmitting video data including video information, and also, a video signal adjustment unit (Re-timer, see FIGS. 14A and 14B) may be connected thereto for ensuring stable signal transmission by compensating for a delay in the video data and compensating for a delay caused along the main channel (or main lane) for transmitting the video data. More specifically, the video signal adjustment unit (Re-timer) may receive video data from the display source side corresponding to a transmitting end side and retransmit the received video data to the display sink side corresponding to a receiving end side. At this time, in order to compensate for the delay on the main channel (main lane) for transmitting the video data, reproduction and readjustment of the video data may be implemented. For example, in an embodiment, in an optical communication module for transmitting video data, the video signal adjustment unit (Re-timer, see FIGS. 14A and 14B) and the photoelectric conversion element may be connected together on the main channel (or main lane) responsible for transmitting the video data.

In an embodiment, on the data transmission channel of the optical communication module (see FIGS. 14A and 14B), the video adjustment unit (Re-timer) and the photoelectric conversion element may be connected on the main channel (or main lane) responsible for transmitting the video data, and the FPGA block described above and the photoelectric conversion element connected onto the main channel (or main lane) may be connected together on the side channel (auxiliary channel or DDC channel) responsible for transmitting video auxiliary data and diagnosis data. In other words, the photoelectric conversion element of the optical communication module (see FIGS. 14A and 14B) may be connected together on the main channel (or main lane) responsible for transmitting the video data and the side channel (auxiliary channel or DDC channel) responsible for transmitting the video auxiliary data and the diagnosis data, so that, for example, video data output from the video adjustment unit (Re-timer) and the video auxiliary data and the diagnosis data that are output from the FPGA block may all be modulated from an electrical signal to an optical signal from the photoelectric conversion module.

In the optical link that is the target of diagnosis and monitoring in the diagnosis and monitoring system according to an embodiment, a data frame for transmitting the video auxiliary data and the diagnosis data together through the side channel may be generated from TDM (see FIG. 17) so that the video auxiliary data and the diagnosis data including the status information about the optical link may be transmitted together through the side channel. For example, the video auxiliary data and the diagnosis data multiplexed on one data frame through TDM from the FPGA block (see FIG. 17) may be converted from the electrical signal to the optical signal through the photoelectric conversion element.

Meanwhile, the optical signal with respect to the video data transmitted from the optical link may be converted into an electrical signal by the photoelectric conversion module (see FIGS. 14A and 14B) and transmitted to the display sync through a conductive line capable of communicating the electrical signal after the video data is reproduced or readjusted through the video adjustment unit (Re-timer). The optical signal with respect to the video auxiliary data and the diagnosis data transmitted from the optical link may be converted into an electrical signal from the photoelectric conversion module and input to the FPGA block. The video auxiliary data and diagnosis data that are input into the FPGA block (see FIG. 16) may be stored in the memory RAM of the FPGA block, the data stored in the memory RAM of the FPGA block may be updated, may be changed according to a logic or process preset in the FPGA block, or may be transmitted to the outside (diagnosis and monitoring system connected to a USB port of an optical communication module including the FPGA block as described below) of the FPGA block according to the preset logic or process.

As described above, on the data transmission channel of the optical communication module (see FIGS. 14A and 14B), the video control unit (Re-timer) and the photoelectric conversion element may be connected to the main channel (or main lane) responsible for transmitting video data, and the FPGA block and the photoelectric conversion element may be connected to the side channel (auxiliary channel or DDC channel) responsible for transmitting video auxiliary data and diagnosis data. Meanwhile, a USB-UART converter may be connected to the data transmission channel between the optical communication module (see FIGS. 14A and 14B) and the diagnosis and monitoring system connected to the USB port of the optical communication module. For example, in an embodiment, the optical communication module may include the USB-UART converter (see FIG. 15) connected between the FPGA block and the USB port. In an embodiment, UART communication data transmitted from the FPGA block through the USB-UART converter may be converted into USB communication data and transmitted to the diagnosis and monitoring system (e.g., diagnosis and monitoring system connected via USB to the optical communication module including the FPGA block) connected to the FPGA block through the data transmission channel, and conversely, USB communication data transmitted from the diagnosis and monitoring system connected via USB to through the USB-UART converter may be converted into UART communication data and transmitted to the FPGA block.

The USB-UART converter may readjust a data structure such as format, coding, signal level, order, etc. of data following a USB communication protocol, control information such as interpretation of the corresponding signal pattern and transmission control and error correction according to the interpretation, and timing such as speed adjustment between communication hosts, transmission time of a message, and transmission order, to a data structure following the UART communication protocol, control information, and timing, and conversely, readjust a data structure following the UART communication protocol, control information, and timing, to a data structure following the USB communication protocol, control information, and timing. For example, the USB-UART converter may perform a process for readjusting a data structure, control information, and timing between different communication protocols.

For example, the USB-UART converter (see FIG. 15) may generate and execute two different threads each including a main function and provided with an execution environment within the same process. In a process providing an execution environment for two different threads, the two different threads may share a code area, a data area, and a heap area of memory, while a stack area may be individually allocated to each thread (see FIG. 12).

In other words, the optical communication module (see FIGS. 14A and 14B) may include the USB-UART converter (see FIG. 15) connected between the FPGA block and the USB port.

The USB-UART converter may include the USB interface (see FIG. 15) as a thread that converts USB communication data transmitted from the diagnosis and monitoring system connected to the USB port into UART communication data transmitted toward the FPGA block, and the UART interface (see FIG. 15) as a thread that converts UART communication data transmitted from the FPGA block into USB communication data transmitted toward the diagnosis and monitoring system connected to the USB port.

That is, the USB-UART converter (see FIG. 15) may generate and execute two different threads each including a main function and provided with an execution environment within the same process. The two different threads may include a thread (USB interface, see FIG. 15) for converting USB communication data following the USB communication protocol to UART communication data following the UART communication protocol, and conversely, a thread (UART interface, see FIG. 15) for converting UART communication data following the UART communication protocol to USB communication data following the USB communication protocol. For example, these different threads may be executed independently of each other. The threads for USB-UART conversion may convert USB communication data or UART communication data that is input to the USB-UART converter into UART communication data or USB communication data in a unit in which error detection or error correction is defined (e.g., data frame unit) or a series of entire continuous signals transmitted from one end toward the other end between communication hosts. When USB-UART conversion occurs in the middle of the unit in which error detection or error correction is defined (e.g., data frame unit) or a series of entire continuous signals transmitted from one end toward the other end between communication hosts, because the USB communication data or UART communication data may be converted into a signal including an error and transmitted to the next stage before error detection or error correction, the conversion of USB-UART may be performed at least in the unit capable of error detection or error correction (e.g., data frame unit or a series of entire continuous signals).

In other words, the USB interface and UART interface (see FIG. 15) may perform the USB-UART conversion after the series of entire continuous data transmitted from one end to the other end between the diagnosis and monitoring system connected to the USB port and the USB-UART converter has been transmitted up to the last byte, or after the series of entire continuous data transmitted from one end to the other end between the FPGA block and the USB-UART converter has been transmitted up to the last byte.

In an embodiment, the USB-UART converter (see FIG. 15) may convert USB communication data into UART communication data following the UART protocol, which is an asynchronous serial communication, so that a separate clock signal may not be accompanied, and data reading may be possible from a baud rate specified by the UART protocol and a start bit (e.g., bit 0) and a stop bit (e.g., bit 1). For example, in an embodiment, the UART communication channel for transmitting the UART communication data may be set to a baud rate of 115200 bps, data bit: 8 bits, non-parity bit, and one stop bit.

In an embodiment, the optical link may include the optical communication module (see FIGS. 14A and 14B) including an FPGA block, and the optical communication module (see FIGS. 14A and 14B) may include the optical transmission module (see FIG. 14A) forming a transmission end side and the optical reception module (see FIG. 14B) forming a reception end side. At this time, the transmission end and the reception end may respectively mean a display source side transmitting video data and a display sink side receiving video data. For example, the video data may form a unidirectional data flow from the display source side toward the display sink side. Unlike the video data, the video auxiliary data and diagnosis data may form a bidirectional data flow between the display source side and the display sink side. For example, a side channel (auxiliary channel or DDC channel) responsible for transmitting the video auxiliary data and diagnosis data may support bidirectional communication of unidirectional data flow from the display source to the display sink, and a reverse directional data flow from the display sink to the display source.

In an embodiment, the optical transmission module (see FIG. 14A) connected to the display source side and the optical reception module (see FIG. 14B) connected to the display sink side may have substantially the same configuration, but the main channel (or main lane) responsible for transmitting video data in each of the optical transmission module and the optical reception module may transmit or receive the flow of video data in opposite directions.

In an embodiment, the display source forming one end of the optical link and the optical transmission module may be formed as a conductive line that accommodates the flow of electrical signals, and the display sink forming the other end of the optical link and the optical reception module may be formed as a conductive line that may accommodate the flow of electrical signals. At this time, the optical transmission module and the optical reception module may be formed in an optical fiber capable of accommodating the flow of optical signals.

In an embodiment, the FPGA block (see FIG. 16) may be involved in the overall management of diagnosis data, such as generation, storage and update of diagnosis data including status information about the optical link including at least one of the connection status of the optical link, the operating status of the optical link (such as operating temperature and operating voltage), and identification information about the optical link itself, and transmission of diagnosis data. For example, the diagnosis and monitoring system (see FIG. 3, e.g., USB host controller of the diagnosis and monitoring system) may form a host of a USB connection while forming the USB connection with the FPGA block (e.g., optical communication module including the FPGA block, see FIGS. 14A and 14B), and the FPGA block (e.g., optical communication module including the FPGA block, see FIGS. 14A and 14B) may form a device of the USB connection. For example, the FPGA block (see FIG. 16) may perform data communication by receiving a request for diagnosis data and/or video auxiliary data and transmitting the requested diagnosis data and/or video auxiliary data through the USB connection with the diagnosis and monitoring system (e.g., USB host controller of the diagnosis and monitoring system, see FIG. 3) as the host connected through the USB port. For example, USB communication data transmitted from the diagnosis and monitoring system (see FIG. 3) may be converted into UART communication data through the USB-UART converter (see FIG. 15), the converted UART communication data may be input to the FPGA block (see FIG. 16) and converted from serial data of the UART communication data to parallel data through the SerDes of the FPGA block, the converted parallel data may perform a set operation, such as reading data from the memory RAM, writing data to the memory RAM, or transmitting diagnosis data and/or video auxiliary data stored in the memory RAM to the diagnosis and monitoring system, according to the logic or process set in the FPGA block. For example, according to the logic or process called according to a request (control command) received from the diagnosis and monitoring system, information stored in the memory RAM of the FPGA block, for example, diagnosis data including at least one of the connection status of the optical link stored in the memory RAM, the operating status of the optical link (operating temperature and operating voltage, etc.), and the identification information about the optical link itself, and/or video auxiliary data including channel configuration data and rendering configuration data may be obtained and transmitted to the diagnosis and monitoring system.

In an embodiment, the diagnosis data including at least one of the connection status of the optical link, the operating status of the optical link, and the identification information about the optical link itself may be stored in the memory RAM of the FPGA block (see FIG. 16), and the diagnosis data stored in the memory RAM of the FPGA block (see FIG. 16) may be transmitted in response to a request (control command) from the diagnosis and monitoring system connected to the USB port of the FPGA block (optical communication module including the FPGA block, see FIGS. 14A and 14B). For example, diagnosis data mainly including status information related to the display source or display sink, such as the connection status between the optical link and the display source or display sink connected adjacent to the FPGA block itself (e.g., presence or absence of an output signal on the display source side or presence or absence of an input signal on the display sink side), and diagnosis data mainly including status information related to the display sink or display source, such as the connection status between the optical link and the display sink or display source connected to the other end of the optical link (e.g., presence or absence of an input signal of the display sink or the presence or absence of an output signal of the display source) may be stored together in the memory of the FPGA block. For example, according to data communication between a first FPGA block connected to the display source side and a second FPGA block connected to the display sink side, the diagnosis and monitoring system may obtain both diagnosis data including status information mainly related to the display source, such as the connection status between the display source and the optical link, and diagnosis data including status information mainly related to the display sink, such as the connection status between the display sink and the optical link, through the first FPGA block (e.g., optical transmission module including the first FPGA block) or the second FPGA block (e.g., optical reception module including the second FPGA block) that may be selectively connected among the first and second FPGA blocks. For example, the first and second FPGA blocks may obtain diagnosis data including status information mainly related to the display sink or display source connected to the opposite side, such as the connection status between the display sink or display source on the opposite side and the optical link, through data communication with each other at a periodically set time interval, store the diagnosis data in their own memory, update or change the diagnosis data stored in their own memory to the latest data.

In various embodiments, both diagnosis data including status information mainly related to the display source or the display sink, such as the connection status with the display source or display sink connected adjacent to the corresponding FPGA block, and diagnosis data including status information mainly related to the display sink or the display source, such as the connection status with the display sink or the display source away from the corresponding FPGA block may be stored in the memory of the FPGA block. At this time, the diagnosis and monitoring system may obtain all diagnosis data (e.g., diagnosis data including status information about other optical links) including status information about an optical link mainly related to the display source and/or the display sink, such as the connection status between the optical link and the display source and the display sink forming both ends of an optical link connection, from the first FPGA block (e.g., optical transmission module including the first FPGA block, see FIG. 14A) or the second FPGA block (e.g., optical reception module including the second FPGA block, see FIG. 14B) selectively connected among the first and second FPGA blocks, and diagnosis data including status information related to the display source and the display sink, including the connection status of the optical link with the display source and display sink stored in the memory of each of the first FPGA block or the second FPGA block, may be transmitted according to a request (control command) of the diagnosis and monitoring system. However, in various embodiments, the first and second FPGA blocks may generate diagnosis data according to a request (control command) of the diagnosis and monitoring system that has formed a USB connection and transmit the generated diagnosis data, and, for example, when the process or logic set in the first and second FPGA blocks is called in response to the request (control command) of the diagnosis and monitoring system, may generate diagnosis data (including status information about other optical links) mainly related to the display source or display sink, such as the connection status between the optical link and the display source or the display sink connected thereto or may also request diagnosis data (including status information about other optical links) mainly related to the display sink or the display source, such as the connection status between the optical link and the display sink or the display source connected to the opposite side of the optical link, from another FPGA block connected to the optical link.

FIG. 17 is a diagram for explaining TDM of video auxiliary data and diagnosis data to transmit the video auxiliary data and the diagnosis data together through a side channel, the diagram explaining forming a data frame in which the video auxiliary data and the diagnosis data are TDM through a multiplexer from an input channel storing the video auxiliary data and the diagnosis data or an input register connected to the input channel and are multiplexed through TDM time slots or sub-frames, and forming a data frame of serial data from SerDes with a data frame of parallel data as input.

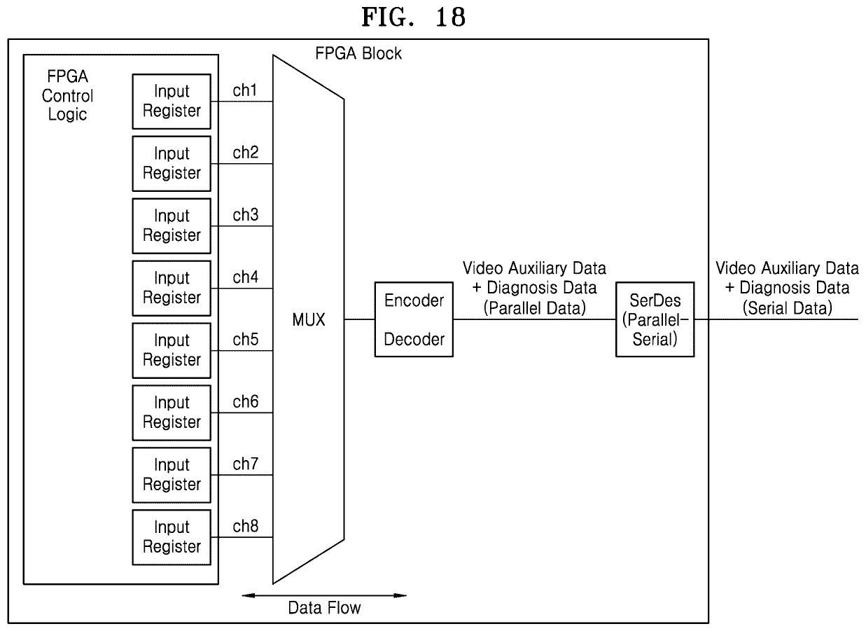

FIG. 18 is a diagram for schematically explaining a processing flow of video auxiliary data and diagnosis data transmitted through a side channel, the diagram explaining an FPGA block including an encoder/decoder having the flow, as input, of multiplexed video auxiliary data and diagnosis data output from MUX for multiplexing first to eight input channels input from an input register of FPGA control logic and a configuration of SerDes to convert parallel data and serial data of the video auxiliary data and the diagnosis data into each other.

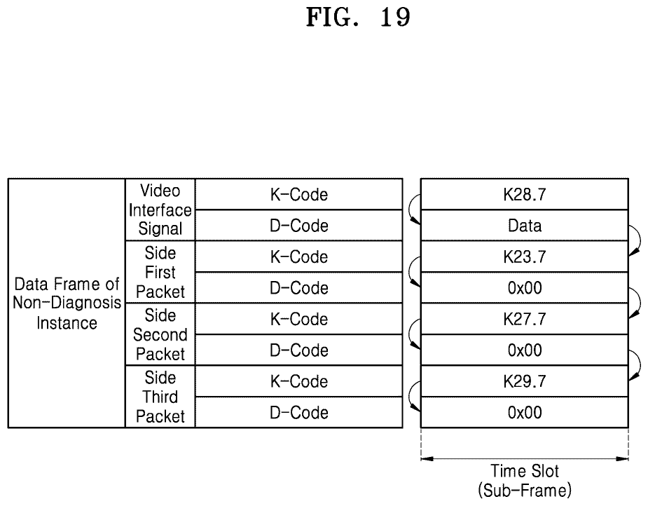

FIG. 19 is a diagram for explaining a data frame of non-diagnosis instance including only video auxiliary data without including diagnosis data.

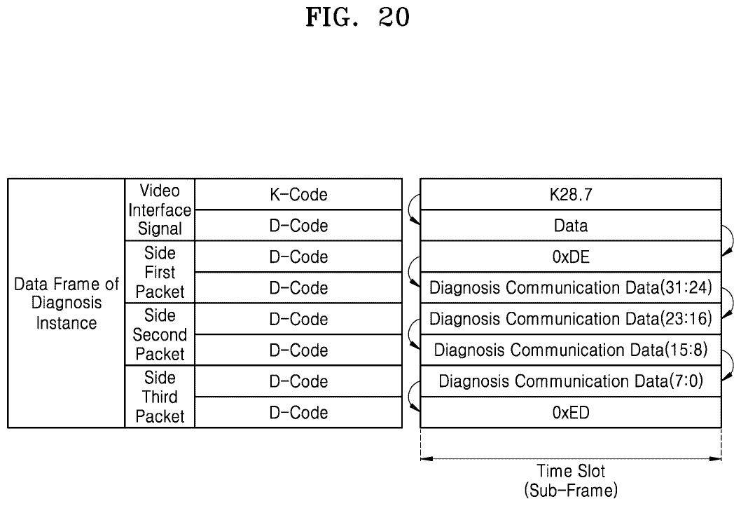

FIG. 20 is a diagram for explaining a data frame of diagnosis instance including diagnosis data along with video data.

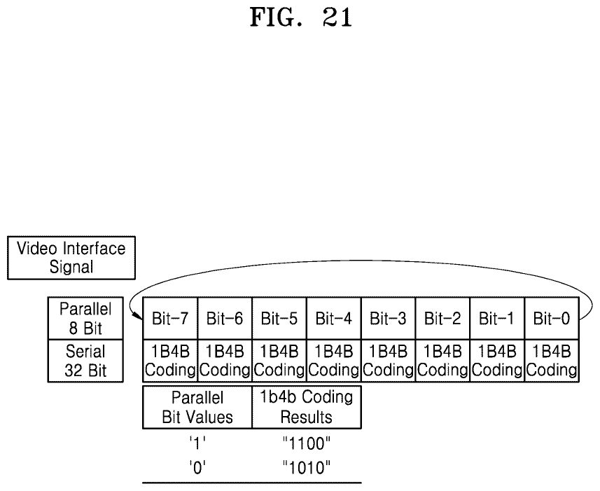

FIG. 21 is a diagram for explaining implementing STDM that stuffs time slots or sub-frames allocated to diagnosis data with stuffing symbols in a data frame of non-diagnosis instance where diagnosis data does not exist according to an embodiment, the diagram explaining compatibility with an optical link to which a certain transmission capacity is allocated in the data frame that do not include diagnosis data.

In an embodiment, the video auxiliary data and the diagnosis data may be transmitted through the same side channel (auxiliary channel or DDC channel), the data frame transmitted through the side channel may include TDM time slots or sub-frames, different types of video auxiliary data and diagnosis data may be transmitted together through one side channel by multiplexing one side channel into a plurality of channels through the TDM time slots or sub-frames (see FIG. 17), and in an embodiment, the data frame of the side channel may be multiplexed in 8-bit units through 8-bit unit time slots or sub-frames. More specifically, in an embodiment, the data frame transmitted through the side channel may include a special code area and a data area transmitted in the TDM time slots or sub-frames, and more specifically, the data frame, which is allocated to the alternately TDM time slots or sub-frames, may include a special code area K-CODE to which a special code (or special character) is allocated as a control symbol and a data area D-CODE (FIGS. 19 and 20).

In an embodiment, the special code area (K-CODE, see FIGS. 19 and 20) may mean the remaining period of the data frame excluding the data area, and may include control information about each period of the data frame, for example, a time slot or sub-frame of the data frame, according to predefined rules between communication hosts (display source, first FPGA block connected to the display source side, display sink, or second FPGA block connected to the display sink side) of the data frame, and, for example, may include control information about each period of the data frame, for example, a time slot or sub-frame of the data frame, on the data frame of the side channel including video data and diagnosis data, such as a special code BS, BE indicating the start or end of a blanking period on the data frame including video data.

In an embodiment, the data frame of the side channel including the video auxiliary data and the diagnosis data (see FIGS. 19 and 20) may have a structure in which the special code area (K-CODE, special code, special character) corresponding to the control symbol and the data area D-CODE are allocated to different time slots or sub-frames along a time axis, and for example, one data frame may have a total transmission capacity of 64 bits including 8 bits of time slot or 8 units of sub-frame. For example, in an embodiment, the data frame (see FIGS. 19 and 20) including diagnosis data and video auxiliary data together from TDM (see FIG. 17) may have a structure in which the special code area K-CODE of 1 byte and the data area D-CODE of 1 byte are alternately allocated so that the diagnosis data and the video auxiliary data may be transmitted together through one side channel. However, in an embodiment, the data frame (see FIG. 19) of the side channel of the non-diagnosis instance that includes video auxiliary data but not include diagnosis data may have a structure in which the special code area K-CODE (special code, special character) and the data code D-CODE are alternately allocated as described above, and the data frame (see FIG. 20) of the side channel of the diagnosis instance that includes both video auxiliary data and diagnosis data may have a different data frame structure from the data frame of the side channel of the non-diagnosis instance. As described above, the data frame (see FIG. 19) of the side channel of the non-diagnosis instance may have the data frame structure in which the special code area K-CODE (special code, special character) and the data area D-CODE are alternately allocated, and in contrast, the data frame (see FIG. 20) of the side channel of the diagnosis instance may have a structure in which the special code area and the data area are alternately allocated in a Video Interface Signal segment corresponding to the start of the frame, but only the data area D-CODE, without the special code area K-CODE, is allocated in a Side First packet segment, a Side Second packet segment, and a Side Third packet segment after the Video Interface Signal segment corresponding to the start of the frame. For example, in an embodiment, the data frame (see FIG. 19) of the side channel of diagnosis instance where diagnosis data exists may have a structure in which only the special code area K-CODE expressing the start of the data frame is allocated, and have only the data area D-CODE, without special code area K-CODE, in the other segments, i.e., Side First packet segment, Side Second packet segment, and Side Third packet segment, except for the special code area K-CODE of the Video Interface Signal segment corresponding to the start of the data frame. For example, diagnosis data start symbol 0xDE and diagnosis data end symbol 0xED, which function as control symbols (or control information) to express the start and end of the Side First packet segment, Side Second packet segment, and Side Third packet segment forming the data area D-CODE, may function as control symbols (or control information) in an embodiment. However, by considering the convenience of a process for generating the data frame, for example, by allocating the entire period of the Side First packet segment, Side Second packet segment, and Side Third packet segment following the Video Interface Signal segment corresponding to the start of the data frame in the process for generating the data frame to the data area D-CODE (diagnosis data) excluding the special code area K-CODE, the diagnosis data start symbol 0xDE and the diagnosis data end symbol 0xED that express the start and end of diagnosis data may be processed in the same way as the generation of diagnosis data as payloads allocated therebetween, and for example, the entire period from a diagnosis data start symbol including the diagnosis data start symbol to a diagnosis data end symbol including the diagnosis data end symbol may be processed as the data area. The diagnosis data start symbol and the diagnosis data end symbol for substantially expressing the start and end of diagnosis data may be respectively allocated to a data area where change or modification of data is possible, so that autonomous communication rules with respect to the start and end of diagnosis data may be set between communication hosts (e.g., display source, first FPGA block on the display source side, display sink, or second FPGA block on the display sink side).

In an embodiment, the video auxiliary data, which is information related to video data transmitted through the main channel (or main lane), such as configuration information about the main channel (or main lane) such as DPCD or rendering configuration information such as EDID, may involve multiple communications including requests and responses according to requests at shorter time intervals than diagnosis data including status information about the optical link, such as connection status with a display source or display sink, operating status of the optical link (operating voltage, operating temperature, etc.), and identification information about the optical link itself. For example, during channel equalization related to configuration of the main channel (or main lane), multiple communications including requests and responses according to requests need to be implemented between the display source and the display sink, such as setting and changing of training patterns, changing of settings of the main channel (or main lane), and information related to the success or failure of channel equalization between the display source and the display sink. As described above, requests for data for channel equalization for configuration of the main channel (or main lane) and responses of the requested data may be transmitted as video auxiliary data through a side channel (auxiliary channel or DDC channel).

In an embodiment, both video auxiliary data and diagnosis data may be transmitted through the side channel (auxiliary channel or DDC channel), but as described above, the video auxiliary data needs to support a relatively large number of communications or a large amount of traffic, such as data requests and responses to requested data. In contrast, the diagnosis data including status information such as the connection status between the display source or the display sink and the optical link, the operating status of the optical link (operating voltage, operating temperature, etc.), and identification information about the optical link itself, may be sufficient even though a relatively small number of communications or a small amount of traffic is supported with respect to data requests and responses to requested data. For example, the communication traffic of video auxiliary data for data request and response to requested data for the video auxiliary data transmitted through the side channel (auxiliary channel or DDC channel), and the communication traffic of diagnosis data of the connection status of the optical link with the display source and the display sink may be set to different numbers of communications or different amounts of traffic. In consideration of the imbalance in the communication traffic between the video auxiliary data and the diagnosis data, in an embodiment, 1) the data frame structure including only the video auxiliary data (data frame structure of the side channel of the non-diagnosis instance, see FIGS. 19) and 2) the data frame structure including both the video auxiliary data and the diagnosis data (diagnosis communication data) (data frame structure of the side channel of the diagnosis instance, see FIG. 20) may be considered.

In an embodiment, the data frames (see FIGS. 19 and 20) for TDM (see FIG. 17) different video auxiliary data and different diagnosis data may include video auxiliary data, according to the presence or absence of diagnosis data, when the diagnosis data exists, a data frame may be formed in which the data area allocated to the diagnosis data is stuffed with diagnosis data, and when the diagnosis data does not exist, a stuffed data frame may be formed in which the data area allocated to the diagnosis data is stuffed with a predefined stuffing symbol (0x00). As described above, a structure of the data frame of non-diagnosis instance (see FIG. 19) where diagnosis data does not exist may have a pattern in which the special code area K-CODE and the data area D-CODE are alternately repeated. For example, in an embodiment, the data frames (see FIGS. 19 and 20) in which video auxiliary data and diagnosis data are multiplexed may include TDM time slots or sub-frames of 8 units, and 8 input channels may be multiplexed with each input channel allocated to a time slot or sub-frame of each unit. For example, the optical link that is a target of diagnosis and monitoring of the diagnosis and monitoring system according to an embodiment may include multiplexer MUX for selecting and outputting an input channel allocated to a current time slot or sub-frame among eight input channels CH1 to CH8 multiplexed through TDM (see FIG. 17) according to the eight input channels CH1 to CH8 and a control signal, and the multiplexer MUX may output any input channel selected from among the eight input channels CH1 to CH8.

For example, in the data frame of non-diagnosis instance where only video auxiliary data exists (see FIG. 19), an 8-bit special code, 8-bit video auxiliary data, and a 8-bit stuffing symbol (stuffing symbol for stuffing the data area allocated to the diagnosis data, e.g., 0x00) for stuffing the special code area, the data area allocated to the video auxiliary data, and the data area allocated to the diagnosis data, respectively, may be stored in the 8 input channels CH1 to CH8 or input registers connected to the 8 input channels CH1 to CH8. In the data frame of diagnosis-instance (see FIG. 20) where both video auxiliary data and diagnosis data exist, an 8-bit special code, 8-bit video auxiliary data, and 8-bit diagnosis data (including a diagnosis data start symbol 0xDE and a diagnosis data end symbol 0Xed) for stuffing a special code of the Video Interface Signal segment corresponding to a frame start, the data area allocated to the video auxiliary data, and the data area allocated to the diagnosis data (diagnosis communication data), respectively, may be stored in the 8 input channels CH1 to CH8 or the input registers connected to the 8 input channels CH1 to CH8.

In an embodiment, even though the diagnosis data does not exist in the input channel allocated to the diagnosis data among each of the eight input channels, the multiplexer MUX (see FIG. 17) may not stuff video auxiliary data other than the diagnosis data in the time slot or sub-frame allocated to the diagnosis data, and may implement stuffing the frame area allocated to the diagnosis data that does not exist with a stuffing symbol (e.g., 0x00). Implementing multiplexing (see FIG. 17) on different video auxiliary data and diagnosis data as described above may correspond to STDM (FIG. 6B) that does not stuff the time slots allocated to each channel for TDM with data of other input channels even though there is no data in the input channel during TDM, and, when data does not exist in the input channel, may not correspond to ATDM (FIG. 6A) that stuffs time slots allocated to input channel where data does not exist with data of other input channels.

For example, in an embodiment, during multiplexing between the video auxiliary data and the diagnosis data, in the data frame (see FIG. 19) of non-diagnosis instance where the diagnosis data does not exist, implementing STDM (FIG. 6B) that stuffs the data area D-CODE allocated to the diagnosis data with the stuffing symbol (0x00) without allocating the data area D-CODE to other input channels (e.g., video auxiliary data) may maintain the data frame of the side channel at a constant data size (8 bytes, 64 bits) regardless of the presence or absence of diagnosis data, and, for example, provide compatibility with the optical link (see FIG. 21) that transmits only video auxiliary data without transmitting diagnosis data through the side channel. For example, the side channel of the optical link according to the comparative example (see FIG. 21) in contrast to the optical link applicable to the disclosure may transmit only video auxiliary data without diagnosis data, video auxiliary data of 8-bit parallel data may transmit a data frame of a constant data size of 32 bits through the side channel through 1b4b coding, in consideration of compatibility with the optical link that maintains a data frame of a constant data size, in an embodiment, multiplexing between video auxiliary data and diagnosis data may be implemented, and in the data frame (see FIG. 19) of non-diagnosis instance where the diagnosis data does not exist, STDM (FIG. 6B) that stuffs the data area D-CODE allocated to the diagnosis data with the stuffing symbol (0x00) without allocating the data area D-CODE to other input channels (e.g., video auxiliary data) may be implemented. For example, in an embodiment, a data frame for implementing TDM between video auxiliary data and diagnosis data may include time slots or sub-frames of 8 units, may form the data frame (see FIGS. 19 and 20) with a total transmission capacity of 64 bits (8 bytes) including time slots or sub-frames of 8 units each allocated with 8 bits (1 byte), and may maintain a constant transmission capacity regardless of the presence or absence of diagnosis data.

In an embodiment, the data frame (see FIG. 19) of non-diagnosis instance including only the diagnosis data without including diagnosis data, and the data frame (see FIG. 20) of diagnosis instance including both video auxiliary data and diagnosis are described as follows.

The data frame including only video auxiliary data (data frame of non-diagnosis instance, see FIG. 19) may have a structure in which the special code area K-CODE and the data area D-CODE to which special codes are allocated are alternately allocated, and a transmission capacity of 8 bits (1 byte) may be allocated to each of the special code area K-CODE and the data area D-CODE. At this time, video auxiliary data may be allocated to D-CODE following the special code area K-CODE (e.g., K28.7) that expresses the start of the data frame along the time axis, and then D-CODE allocated alternately with the following special code area K-CODE (e.g., K23.7, K27.7, K29.7) may be stuffed with the stuffing symbol (0x00) (STDM, FIG. 6B). In an embodiment, the data frame of the side channel may include Video Interface Signal segments (each including the special code area K-CODE of 1 byte and the data area D-CODE) allocated to video auxiliary data, Side First packet segments (each including the special code area K-CODE of 1 byte and the data area D-CODE), Side Second packet segments (each including the special code area K-CODE of 1 byte and the data area D-CODE), and Side Third packet segments (each including the special code area K-CODE of 1 byte and the data area D-CODE). In an embodiment, the video auxiliary data and the diagnosis data may be transmitted in the side channel (auxiliary channel or DDC channel), the data frame (see FIG. 20) of the side channel including the video auxiliary data and the diagnosis data may include the Video Interface Signal segment corresponding to the start of the frame and the Side Third packet segment corresponding to the end of the frame, and may include the Side First packet segment and the Side Second packet segment disposed between the Video Interface Signal segment and the Side Third packet segment corresponding to the start and end of the frame. In addition, each of the segments (Video Interface Signal, Side First packet, Side Second packet, Side Third packet) forming the data frame may include the special code area K-CODE to which 1 byte is allocated and the data area D-CODE. Here, the video auxiliary data may be allocated to the Video Interface Signal segment (more specifically, the data area D-CODE of the Video Interface Signal segment) corresponding to the start of the data frame, the diagnosis data (diagnosis communication data) may be allocated to each of the Side First packet, Side Second packet, and Side Third packet segments (D-CODE of the Side First packet, Side Second packet, and Side Third packet segments), in the data frame (see FIG. 19) of non-diagnosis instance where the diagnosis data does not exist, the stuffing symbol (0x00) may be stuffed in each of Side First packet, Side Second packet, and Side Third packet segment (D-CODE of each of the Side First packet, Side Second packet, and Side Third packet segments), and in the data frame (see FIG. 20) of diagnosis instance where the diagnosis data exists, the diagnosis data (diagnosis communication data) may be stuffed in each of the Side First packet, Side Second packet, and Side Third packet segments (D-CODE of the Side First packet, Side Second packet, and Side Third packet segments).

In various embodiments, in the data frame (see FIG. 19) of non-diagnosis instance where the diagnosis data does not exist, the special code area K-CODE and the data area D-CODE may be allocated alternately, in the data frame (see FIG. 20) of diagnosis instance where the diagnosis data exists, the Video Interface Signal segment corresponding to the start of the data frame may include the special code area K-CODE expressing the start of the data frame and the data area D-CODE allocated to the video auxiliary data, similar to the data frame (see FIG. 19) of non-diagnosis instance where the diagnosis data does not exist, but only the data area D-CODE may be allocated to the Side First packet, Side Second packet, and Side Third packet segments which are the remaining segments following the Video Interface Signal segment corresponding to the start of the data frame without the special code area K-CODE. However, the diagnosis data start symbol (0xDE) and the diagnosis data end symbol (0xED) indicating the start and end of diagnosis data (diagnosis communication data) may be respectively allocated to the preceding data area D-CODE of the Side First packet segment and the following data area D-CODE of the Side Third packet segment among the data areas D-CODE of the Side First packet, Side Second packet, and Side Third packet segments. Unlike the special code area K-CODE, the diagnosis data start symbol and the diagnosis data end symbol where change or modification is possible according to autonomous rules between the communication hosts (first FPGA block on the display source side and second FPGA block on the display sink side) may be respectively allocated. For example, the data frame (see FIG. 20) of diagnosis instance including the diagnosis data (diagnosis communication data) may include the special code area K-CODE of 1 byte (8 bits) and the data area D-CODE, similar to the data frame (see FIG. 19) of non-diagnosis instance, the special code area and data area of the Video Interface Signal segment may each be allocated 1 byte, only the data area D-CODE may be allocated to the following remaining Side First packet, Side Second packet, and Side Third packet segments without the special code area K-CODE, and 1 byte (8 bits) may be allocated to each data area D-CODE. As described above, among the Side First packet, Side Second packet, and Side Third packet segments following the Video Interface Signal segment, the diagnosis data start symbol (0xDE) and the diagnosis data end symbol (0xED) may be respectively allocated to the preceding data area (1 byte, 8 bits) corresponding to the start of the Side First packet segment and the following data area (1 byte, 8 bits) corresponding to the end of the Side Third packet segment, and diagnosis data may be allocated to each of the remaining data areas (1 byte, 8 bits).

In other words, with respect to a data frame for TDM different video auxiliary data and diagnosis data, according to the presence or absence of diagnosis data, the data frame (see FIG. 19) of non-diagnosis instance where the diagnosis data does not exist may include special code areas and data areas that are alternately allocated to TDM time slots or sub-frames of 8 unit.

The data frame (see FIG. 20) of diagnosis instance where the diagnosis data exists may include a sequence of special code areas allocated to time slots or sub-frames of a unit corresponding to the start of the data frame in TDM time slots or sub-frames of 8 unit, and data areas allocated to time slots or sub-frames of the remaining unit following the time slot or sub-frames of the unit to which the special code areas are allocated along the time axis.

More specifically, the data frame (see FIG. 19) of non-diagnosis instance where the diagnosis data does not exist and the data frame (see FIG. 20) of diagnosis instance where the diagnosis data exists may commonly include the Video Interface Signal segment corresponding to the start of the data frame, and the Side First packet, Side Second packet, and Side Third packet segments that follow the Video Interface Signal segment along the time axis.

The Video Interface Signal segment may include a special code area and a data area.

The special code area of the Video Interface Signal segment may be allocated to the special code indicating the start of the data frame.

The data area of the Video Interface Signal segment may be allocated to video auxiliary data.

For example, the Side First packet, Side Second packet, and Side Third packet segments of the data frame (see FIG. 20) of diagnosis instance may each include a special code area and a data area.

The data areas of the Side First packet, Side Second packet, and Side Third packet segments may be stuffed with stuffing symbols to replace diagnosis data that does not exist.

For example, the Side First packet, Side Second packet, and Side Third packet segments of the data frame (see FIG. 20) of diagnosis instance may each include preceding and following time slots or sub-frames of 2 unit along the time axis.

The preceding time slot of the Side First packet may be stuffed with a diagnosis data start symbol, and the following time slot of the Side Third packet may be stuffed with a diagnosis data end symbol.

The time slot from the following time slot of the Side First packet to the preceding time slot of the Side Third packet may be stuffed with diagnosis data (diagnosis communication data) along the time axis.

At this time, the preceding time slot or preceding sub-frame of the Side First packet and the following time slot or following sub-frame of the Side Third packet are stuffed with a diagnosis data start symbol and a diagnosis data end symbol, respectively, and the preceding time slot or following sub-frame of each Side First packet and the following time slot or following sub-frame of the Side Third packet may be allocated as a data area where modification is possible between communication hosts.

For example, the TDM slot or sub-frame may be allocated with 8 bits, and the data frame may be allocated with a total of 64 bits of 8 unit, with each TDM time slot or sub-frame allocated with 8 bits as a unit.

In an embodiment, with respect to the generation of the data frame of the side channel including the video auxiliary data and the diagnosis data (see FIG. 17), the FPGA block may include 8 input channels into which special codes, video auxiliary data, and diagnosis data are input (e.g., 8 input channels connected to input registers in which special codes, video auxiliary data, and diagnosis data (or stuffing symbols) are stored), and the multiplexer MUX for implementing multiplexing on the 8 input channels. For example, in an embodiment, the multiplexer MUX may form a sequence of parallel data (8 bits) in which special codes, video auxiliary data and diagnosis data (or stuffing symbols) input through the 8 input channels are transmitted through each allocated time slot or sub-frame. As described above, line encoding and/or block encoding may be performed with the sequence, as input, of parallel data (8 bits) in which special codes, video auxiliary data and diagnosis data (or stuffing symbols) are multiplexed (or mixed) (see FIG. 18). For example, an encoder for performing line encoding and/or block encoding may balance positive and negative voltages (DC balance) with respect to the parallel data in which special codes, video auxiliary data and diagnosis data (or stuffing symbols) are multiplexed (or mixed) so that signal distortion due to a DC component does not occur, and perform proper line encoding by considering synchronization between a display source and a display sink. In addition, the encoder may convert, for example, an 8-bit input into a 10-bit output (8b/10b encoding) with respect to the parallel data in which special codes, video auxiliary data and diagnosis data (or stuffing symbols) are multiplexed (or mixed), perform block encoding to balance positive and negative voltages, and identify for data transmission errors (bit errors).

For example, in an embodiment, the FPGA block (see FIG. 16) may include an FPGA control logic (programmable fabric) including an array of programmable logic blocks and performing processing according to a predefined process or logic, and the memory RAM performing data read, write, update, etc. (e.g., create, read, update, and delete (CRUD)) in conjunction with the FPGA control logic, may additionally include the multiplexer (see FIG. 17) for multiplexing the diagnosis data and video auxiliary data processed according to the FPGA control logic, the encoder for line encoding and/or block encoding (see FIG. 18, encoder/decoder), and the SerDes for converting parallel data forming the diagnosis data and video auxiliary data processed according to FPGA control logic (sequence of parallel data forming a data frame in which diagnosis data (or stuffing symbols) and video auxiliary data are multiplexed, or sequence of parallel data in which diagnosis data (or stuffing symbols) and video auxiliary data are multiplexed) into serial data (sequence of serial data forming a data frame in which diagnosis data (or stuffing symbols) and video auxiliary data are multiplexed, or sequence of serial data in which diagnosis data and video auxiliary data are multiplexed) or for converting serial data transmitted from the display source, display sink, or FPGA block on the opposite side through an optical link (sequence of serial data forming the data frame in which diagnosis data (or stuffing symbols) and video auxiliary data are multiplexed, or sequence of serial data in which diagnosis data (or stuffing symbols) and video auxiliary data are multiplexed) into parallel data suitable for processing of the FPGA block (sequence of parallel data forming the data frame in which diagnosis data (or stuffing symbols) and video auxiliary data are multiplexed, or sequence of parallel data in which diagnosis data (or stuffing symbols) and video auxiliary data are multiplexed).

More specifically, in an embodiment, the FPGA block (see FIG. 17) may include the multiplexer MUX that implements multiplexing between input channels (first to eighth input channels) connected to input registers in which special codes are stored from the FPGA control logic, input channels (first to eighth input channels) connected to input registers that receive the video auxiliary data processed from the FPGA control logic, and input channels (first to eighth input channels) connected to input registers that receive the diagnosis data output from the FPGA control logic as a processing flow of another data, the encoder (see FIG. 18) with a sequence, as input, of parallel data (8 bits) including special code, video auxiliary data, and diagnosis data output from the multiplexer MUX (sequence of parallel data forming a data frame in which diagnosis data (or stuffing symbols) and video auxiliary data are multiplexed, or sequence of parallel data in which diagnosis data (or stuffing symbols) and video auxiliary data are multiplexed) and encodes the input sequence of parallel data, and the SerDes (shift register) that outputs the sequence of parallel data input according to a parallel clock as a sequence of serial data according to a serial clock (sequence of serial data forming a data frame in which diagnosis data (or stuffing symbols) and video auxiliary data are multiplexed, or sequence of serial data in which diagnosis data (or stuffing symbols) and video auxiliary data are multiplexed). For example, in an embodiment, the FPGA block (the first FPGA block or the second FPGA block) may process video auxiliary data and diagnosis data transmitted from the display source or the display sink, and video auxiliary data and diagnosis data according to a process or logic that defines a preset operation such as storing, changing, and updating (create, read, update, delete (CRUD)) of video auxiliary data and diagnosis data transmitted from the second FPGA block on the display sink side or the first FPGA block on the display source side. For example, the video auxiliary data and the diagnosis data transmitted from the display source or the display sink, and the video auxiliary data and the diagnosis data transmitted from the second FPGA block on the display sink side or the first FPGA block on the display source side may be converted into the sequence of serial data (sequence of serial data forming the data frame in which diagnosis data (or stuffing symbols) and video auxiliary data are multiplexed, or sequence of serial data in which diagnosis data (or stuffing symbols) and video auxiliary data are multiplexed) through processing from an input register of the FPGA control logic or an input register connected to the FPGA control logic to the SerDes (shift register) and transmitted to the other end of an optical link through the optical link. For example, the FPGA block (the first FPGA block or the second FPGA block) may, together with processing of video auxiliary data and diagnosis data transmitted from the display source or the display sink, use raw data, as input, (e.g., video auxiliary data such as hot plug detection (HPD) or other data, e.g., presence or absence of an output signal of the display source or presence or absence of an input signal of the display sink) transmitted from the display source or the display sink, and generate diagnosis data of status information about the optical link, such as a connection status with the display source or the display sink, an operating status of the optical link (operating temperature, operating voltage, etc.), and identification information about the optical link itself. The FPGA block may include an input register for receiving diagnosis data output from the FPGA control logic. As described above, through an output channel of the multiplexer that implements multiplexing between the input channels (first to eighth input channels) into which diagnosis data output from the input register according to the parallel clock is input and the input channels (first to eighth input channels) into which video auxiliary data is input, a sequence of parallel data including the video auxiliary data and the diagnosis data (sequence of parallel data forming a data frame in which the diagnosis data (or stuffing symbols) and the video auxiliary data are multiplexed, or sequence of parallel data in which the diagnosis data (or stuffing symbols) and the video auxiliary data are multiplexed) may be converted into a sequence of serial data including the video auxiliary data and the diagnosis data (sequence of serial data forming a data frame in which the diagnosis data (or stuffing symbols) and the video auxiliary data are multiplexed, or sequence of serial data in which the diagnosis data (or stuffing symbols) and the video auxiliary data are multiplexed), through the encoder for performing line encoding and/or block encoding and the SerDes (shift register) for conversion to serial data for data transmission through the optical link, and transmitted to the other end of the optical link through the optical link. For example, the multiplexer MUX (see FIG. 17) may implement multiplexing between the first to eighth input registers that output special codes, video auxiliary data, and diagnosis data according to parallel clocks, or between the first to eighth channels connected to the first to eighth input registers, and may output a sequence of parallel data including special codes, video auxiliary data, and diagnosis data through multiplexing between the first to eighth channels according to switching of control signals synchronized with time slots or sub-frames for TDM (switching of control signals synchronized with parallel clocks). In addition, the SerDes (shift register) may use a sequence, as input, of parallel data including special codes, video auxiliary data, and diagnosis data output from the output channel of the multiplexer, and sequentially output a sequence of serial data including special codes, video auxiliary data, and diagnosis data according to a serial clock.

Referring to FIG. 17, the input register, multiplexer, encoder and SerDes (shift register, serializer and deserializer, parallel to serial, serial to parallel) may be synchronized with parallel clocks as input, and for example, the multiplexer may output parallel data of special codes, video auxiliary data and diagnosis data allocated to time slots or sub-frames synchronized with the parallel clocks, and accordingly, the SerDes (shift register) may receive the parallel data according to the parallel clocks synchronized with the input register, multiplexer and encoder, and output serial data of special codes, video auxiliary data and diagnosis data according to serial clocks.

In an embodiment, a data frame of a side channel including video auxiliary data and diagnosis data or a data frame having the structure as described above may include time slots or sub-frames of 8 unit for time division (each unit: 8 bits, 1 byte). For example, in an embodiment, the data frame (see FIG. 19) of non-diagnosis instance including only video auxiliary data and not including the diagnosis data may have a structure in which the special code area K-CODE and the data area D-CODE are alternately allocated, and the stuffing symbol (0x00) may be stuffed in the data area D-CODE to which diagnosis data is allocated. Unlike this, in the data frame (see FIG. 20) of the side channel of the diagnosis instance including both video auxiliary data and diagnosis data, except for the special code area (K28.7) expressing the start of the data frame, all other areas may be allocated as data area D-CODE, and the data area D-CODE between the diagnosis data start symbol (0xDE) expressing the start of diagnosis data and the diagnosis data end symbol (0xED) expressing the end of diagnosis data may be stuffed with diagnosis data. In an embodiment, each special code area K-CODE and data area D-CODE forming a data frame may be allocated as 1 byte (8 bits), and the data capacity of time slots or sub-frames for TDM of the data frame including each special code area K-CODE and data area D-CODE may be determined according to the data capacity of the data frame (8 bytes, 64 bits) and the transmission speed of the optical link (e.g., 16 MBps-byte per second).

For example, the optical link that is a target of diagnosis and monitoring of the diagnosis and monitoring system according to an embodiment may be connected between a display source and a display sink forming the diagnosis and monitoring system that supports HDMI or Display Port (DP), and may transmit video data including video information, and video auxiliary data including rendering configuration data such as Extended Display Identification Data (EDID) in relation to rendering of the display sink and channel configuration data such as Display Port Configuration Data (DPCD) in relation to channel configuration of a main channel (or main lane) that transmits the video data.

More specifically, the video auxiliary data may be transmitted through the side channel (DDC channel of HDMI or auxiliary channel of DP) rather than the main channel (main channel of HDMI or main lane of DP) for transmitting high-speed video data in the HDMI and the DP, may include a video auxiliary signal such as SCL (clock line of DDC channel), SDA (data line of DDC channel), 5V power supply DDC_5V, HPD, Customer Electronic Control (CEC) in the HDMI, and may include a video auxiliary signal such as HPD and DPCD in the DP.

According to an embodiment, diagnosis data may be monitored through a graphic interface screen rendered from a Graphic User Interface (GUI) program running on an administrator interface connected over a communication network to the diagnosis and monitoring system connected to a USB port of the optical transmission module (see FIG. 14A) connected to the display source side or the optical reception module (see FIG. 14B) connected to the display sink side. As described above, the output status of the screen rendered on the display sink side may be identified through a diagnosis and monitoring function implemented from the diagnosis and monitoring system according to an embodiment, and when the screen is not output or the output screen status is not good, maintenance costs such as re-connection or repair may be reduced through the diagnosis and monitoring function provided from the diagnosis and monitoring system according to an embodiment.

For example, the diagnosis data that is a target of diagnosis and monitoring of the diagnosis and monitoring system according to an embodiment may include a connection status between the display source and the display sink (connection status on the display source and the display sink (e.g., connection status of the optical link that mediates the transmission of video data with the display source and connection status of the optical link with the display sink between the display source and the display sink), presence or absence of an output signal on the display source side, presence or absence of an output signal on the display sink side, presence or absence of a signal for each channel on the display sink side (Channel 0, Channel 1, Channel 2, Clock Channel (Pixel Clock) of HDMI, Lane 0, Lane 1, Lane 2, Lane 3 of Display Port), a communication status between the display source and the display sink (e.g., communication status of a side channel that supports bidirectional communication between the display source and the display sink), an operating status of the optical link (operating temperature, operating voltage, etc.), identification information about the optical link (identification information about USB device-optical link recognized from a combination of Vender ID (VID) and Product ID (PID) of the USB device-optical link recognized from the diagnosis and monitoring system (e.g., USB host controller of the diagnosis and monitoring system) that forms a host side and the optical link as a device side of USB communication between a communication host-optical link where a USB communication channel is configured and the diagnosis and monitoring system), etc. For example, in an embodiment, it may be determined whether an optical link corresponds to a target of diagnosis and monitoring by determining whether the optical link with USB communication channel configured with the diagnosis and monitoring system is a preset or predefined USB device.

In various embodiments, between a GUI program for providing a graphical interface on the diagnosis and monitoring system or the administrator interface connected to the diagnosis and monitoring system over the communication network and the optical link, it is necessary to match a format of Application Programming Interface (API), such as a format or structure of communication data, and also, in order for diagnosis and monitoring to be provided from the diagnosis and monitoring system, the USB device connected via USB needs to be limited to an optical link, and thus, the diagnosis and monitoring system (e.g., USB host controller of the diagnosis and monitoring system) needs to determine whether a product of the USB device in which the USB communication channel is formed is an optical link. As described above, the diagnosis and monitoring system (e.g., USB host controller of the diagnosis and monitoring system) that determines that the recognized USB device is out of a preset or predefined range based on a combination of VID and PID read from the configuration of the USB device in which the USB communication channel is formed may not perform any further diagnosis and monitoring, may output an output of the GPIO pin of the USB host controller to a low output level indicating USB disconnection, and may output an error message on the graphic interface screen.

For example, in an embodiment, between the optical link and the diagnosis and monitoring system, the video quality rendered on the display sink side may be optimized by changing or fixing the video auxiliary data including rendering configuration data such as EDID in relation to rendering of the display sink and channel configuration data such as DPCD in relation to channel configuration of the main channel (or main lane) transmitting video data.

The diagnosis and monitoring system for implementing diagnosis and monitoring according to an embodiment may be involved in the overall management of video auxiliary data and diagnosis data, such as requesting video auxiliary data and diagnosis data, transmitting the requested video auxiliary data and diagnosis data, and updating and changing video auxiliary data and diagnosis data. In an embodiment, the video auxiliary data and the diagnosis data may be time-division multiplexed and transmitted together through the side channel excluding the main channel (or main lane) for high-speed transmission of video data so that the overall management of video auxiliary data and diagnosis data may be implemented through the diagnosis and monitoring system, and the video auxiliary data and the diagnosis data that are different from each other may be transmitted together through the side channel via time-division multiplexed data frames. As described above, the video auxiliary data and the diagnosis data may be transmitted together through the side channel of the optical link connecting between the display source and the display sink or between the first FPGA block on the display source side and the second FPGA block on the display sink side, through the diagnosis and monitoring system forming a USB connection with any one FPGA block (optical communication module including the FPGA block) selected from among the first and second FPGA blocks (optical transmission module or optical reception module including the first and second FPGA blocks), or through the administrator interface connected to the diagnosis and system over the communication network, both diagnosis data mainly related to the display source (such as connection status between the display source and the optical link, presence or absence of an output signal of the display source) and diagnosis data mainly related to the display sink (such as connection status between the display sink and the optical link, presence or absence of an input signal from the display sink) may be obtained, management of video auxiliary data, such as requesting, updating, and modifying the video auxiliary data communicated between the first FPGA block on the display source side and the second FPGA block on the display sink side may be possible, for example, diagnosis data may be generated from video auxiliary data or from other data transmitted from the display source side and the display sink side together with the video auxiliary data, and diagnosis data generated through the diagnosis and monitoring system according to an embodiment may be requested, and the requested diagnosis data may be received or changed.

According to the disclosure, the system capable of implementing diagnosis and monitoring of a plurality of optical links may be provided, the system capable of monitoring diagnosis data of statuses of optical links, such as information about connection statuses of optical links, information about operating statuses of optical links such as operating temperature or operating status, and identification information about optical links themselves, and providing diagnosis and monitoring on video data including channel configuration information about a main channel through which video data is transmitted and rendering configuration information about the video data.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A system for monitoring diagnosis data comprising status information of a plurality of optical links forming a main channel for transmitting video data and a side channel for transmitting video auxiliary data comprising rendering information about the video data or channel configuration information about the main channel, the system comprising:
a plurality of universal serial bus (USB) host controllers configured to form a communication host at another end of a USB communication channel with each of the plurality of optical links as a communication host at one end;
a field programmable gate array (FPGA) circuit to which the plurality of USB host controllers are connected in parallel; and
a microcontroller (MCU) connected to the FPGA circuit.

2. The system of claim 1, wherein each of the plurality of optical links and each of the plurality of USB host controllers are configured to form a one-to-one USB communication channel.

3. The system of claim 1, wherein the FPGA circuit is configured to independently perform parallel processing input/output data with the plurality of USB host controllers connected in parallel.

4. The system of claim 1, wherein a data transmission channel through which input/output data with respect to the plurality of optical links are transmitted is formed as a separate connection channel with respect to each of the plurality of optical links between the plurality of host controllers and the FPGA circuit and as a single connection channel between the FPGA circuit and the MCU.

5. The system of claim 1, wherein the FPGA circuit includes a multiplexer for time division multiplexing (TDM) of a plurality of connection channels respectively connected to the plurality of optical links.

6. The system of claim 5, wherein
the multiplexer is configured to multiplex data related to the plurality of optical links, the multiplexer multiplexing data input and output through the plurality of connection channels through time-divided time slots, and
the MCU is configured to perform multiprocessing on the data related to the plurality of optical links, the MCU multiprocessing the data input and output through the multiplexer of the above FPGA circuit in a time division manner.

7. The system of claim 5, wherein the multiplexer is configured to implement asynchronous TDM (ATDM) in which time slots allocated to an optical link switched from a USB connection status to a USB disconnection status are allocated to another optical link in the USB connection status.

8. The system of claim 7, wherein the MCU is configured to skip to a task related to the other optical link in the USB connection status without performing a task related to the optical link switched to the USB disconnection status according to ATDM of the multiplexer.

9. The system of claim 1, wherein each of the plurality of USB host controllers includes a general purpose IO (GPIO) pin of which output level is switched to a high/low signal according to USB connection/disconnection of an optical link forming a one-to-one USB communication channel with itself.

10. The system of claim 9, wherein the MCU is configured to initiate a reset operation on each of the plurality of USB host controllers in which switching of the output level of the GPIO pin is detected.

11. The system of claim 10, wherein as the reset operation of each of the plurality of USB host controllers is initiated, a configuration channel (CC) of the USB host controller is connected to a pull-up resistor and the output level is initialized so that each of the plurality of USB host controllers is role-selected as a host (down facing port (DFP)) according to a USB connection.

12. The system of claim 9, wherein each of the plurality of USB host controllers is configured to switch the output level of the GPIO pin to a high signal indicating the USB connection when it is determined that a USB device corresponds to a range of a preset optical link as a target of diagnosis and monitoring from a combination of a vender ID (VID) and a product ID (PID) obtained through device emulation of the USB device where a connection is detected.

13. The system of claim 1, further comprising: a communication module for configuring an Ethernet communication channel between the system and an administrator interface.

14. The system of claim 13, wherein
according to a power on/off control command of each of the plurality of optical links received from the administrator interface, the MCU is configured to control each of the plurality of USB host controllers forming the communication host of the USB communication channel with each of the plurality of optical links to initiate or cut off power supply to each of the plurality of optical links through a USB connection from each of the plurality of USB host controllers, and
each of the plurality of USB host controllers is configured to switch the output level of the GPIO pin to instruct a USB connection of each of the plurality of optical links to which power supply is initiated or a USB disconnection of each of the plurality of optical links to which power supply is cut off.

15. The system of claim 1, further comprising: a universal achromous receiver/transmitter (UART)-parallel converter connected between the FPGA circuit and each of the plurality of USB host controllers along the data transmission channel through which input/output data with respect to the plurality of optical links are transmitted,
wherein each of the plurality of USB host controllers includes
a UART interface as a thread executed to convert UART communication data transmitted from the UART-parallel converter into USB communication data transmitted toward each of the plurality of optical links; and
a USB interface as a thread executed to convert the USB communication data transmitted from each of the plurality of optical links into the UART communication data transmitted toward the UART-parallel converter.

16. The system of claim 15, wherein
the UART interface and the USB interface are configured to execute a UART-USB conversion,
after a series of entire continuous data from one side to the other side between the UART-parallel converter and each of the plurality of USB host controllers is completely transmitted to a last byte, or
after a series of continuous data from one side to the other side between each of the plurality of the optical links and each of the plurality of USB host controllers is completely transmitted to the last byte.

17. The system of claim 15, wherein the threads forming the UART interface and the USB interface are executed independently of each other, whereas global variables of USB connection/disconnection are stored in a data area of memory that is shared within a same process providing an execution environment and are shared between different threads.

18. The system of claim 1, wherein the diagnosis data includes at least one of connection statuses of the plurality of the optical links, operating statuses of the plurality of the optical links, or identification information about the plurality of the optical links themselves.

19. The system of claim 1, wherein the system is configured to provide diagnosis and monitoring of the video auxiliary data in addition to the status information about each of the plurality of the optical links.

20. The system of claim 19, wherein the video auxiliary data includes channel configuration data related to channel configuration of the main channel for transmitting the video data and rendering configuration data related to rendering of a display sink where the video data is rendered.

21. The system of claim 1, wherein according to a control command received from an administrator interface connected over a communication network, the MCU is configured to perform processing for requesting the diagnosis data and/or the video auxiliary data, receiving the requested diagnosis data, and/or changing the diagnosis data and/or the video auxiliary data.

22. The system of claim 1, wherein each of the plurality of optical links is configured to form the USB communication channel with each of the plurality of USB host controllers through an FPGA block connected on the side channel.
